(19) United States
(12) Patent Application Publication
(10) Pub. No.: US 2024/0273603 A1
(43) Pub. Date: Aug. 15, 2024

(54) SYSTEMS AND METHODS FOR FLEXIBLE OBJECT ACTIVATION

(71) Applicant: Loop Commerce, Inc., Stamford, CT (US)

(72) Inventor: Gabriel Saunkeah, Stamford, CT (US)

(21) Appl. No.: 18/438,843

(22) Filed: Feb. 12, 2024

Related U.S. Application Data
(60) Provisional application No. 63/484,274, filed on Feb. 10, 2023.

(51) Int. Cl. G06Q 30/0601; G06K 7/14

(52) U.S. Cl. CPC G06Q 30/0631; G06K 7/1417

(57) ABSTRACT

Systems and methods are provided for generating flexible gift objects that can be provided to recipients while allowing the recipients to activate the flexible gift objects and assign the flexible gift objects to specific entities. The systems and methods can provide a user with options for defining a gift object category for a flexible gift object for a recipient. The gift object category is associated with a set of entities to which the flexible gift object can be assigned. The recipient receiving the flexible gift object can scan the flexible gift object to identify the gift object category associated with the flexible gift object and select an entity to which the flexible gift object is to be assigned. Upon assignment of the flexible gift object to the selected entity, the flexible gift object is activated, and the recipient can use the flexible gift object with the selected entity.

### CROSS-REFERENCE TO RELATED APPLICATIONS

The present patent application claims the priority benefit of U.S. provisional patent application No. 63/484,274 filed Feb. 10, 2023, the disclosures of which are incorporated by reference herein.

### FIELD

The present disclosure relates to systems and methods for generating flexible gift objects that are initially unassigned to a particular entity. Recipients of the flexible gift objects can selectively assign these flexible gift objects when activating the flexible gift objects for use, providing these recipients with flexibility in determining which entities the flexible gift objects can be assigned to.

### SUMMARY

Disclosed embodiments provide a framework for generating flexible gift objects that can be provided to recipients while allowing the recipients to activate the flexible gift objects and assign the flexible gift objects to specific entities. According to some embodiments, a computer-implemented method is provided. The computer-implemented method comprises receiving a gifting request to associate a flexible gift object with a recipient. The gifting request includes identifying information associated with the recipient. Further, the gifting request defines a gift object category. The flexible gift object further includes a machine-readable label. The computer-implemented method further comprises dynamically associating the machine-readable label with the identifying information associated with the recipient and the gift object category through data encoded in the machine-readable label. The computer-implemented method further comprises receiving an activation request to activate the flexible gift object. The activation request includes the data. Further, the data is extracted from the machine-readable label. The computer-implemented method further comprises processing the data extracted from the machine-readable label in real-time to retrieve the identifying information associated with the recipient and the gift object category. The computer-implemented method further comprises providing a set of assignment options corresponding to the gift object category. The set of assignment options correspond to entities associated with the gift object category. The computer-implemented method further comprises receiving a selection of an assignment option. The selection corresponds to a particular entity associated with the gift object category. The computer-implemented method further comprises dynamically associating the data encoded in the machine-readable label with the particular entity such that when the data is dynamically associated with the particular entity, the flexible gift object is activated for use in transactions associated with the particular entity.

In some embodiments, the machine-readable label is a Quick Response (QR) code.

In some embodiments, the computer-implemented method further comprises automatically generating a set of recommendations corresponding to different gift object categories for defining the flexible gift object. The set of recommendations are generated based on the identifying information associated with the recipient. The computer-implemented method further comprises providing the set of recommendations such that when the set of recommendations are received, the gift object category is selected for the gifting request.

In some embodiments, the computer-implemented method further comprises automatically generating a set of recommendations corresponding to the set of assignment options. The set of recommendations are generated based on the identifying information associated with the recipient and the gift object category. The computer-implemented method further comprises providing the set of recommendations.

In some embodiments, the activation request is received as a result of the machine-readable label being scanned using a computing device associated with the recipient.

In some embodiments, the gifting request is received as a result of the machine-readable label being scanned using a computing device associated with a sender of the flexible gift object.

In some embodiments, the activation request is received through a point-of-sale terminal associated with the particular entity.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a flexible gift object is generated and provided to a recipient to allow the recipient to select the particular entity to which the flexible gift object is to be assigned upon activation of the flexible gift object in accordance with at least one embodiment;

FIG. 2 shows an illustrative example of an environment in which a flexible gift object is generated and associated with a machine-readable label through which the flexible gift object can be assigned to a particular entity upon activation of the flexible gift object in accordance with at least one embodiment;

FIGS. 3A-3B show an illustrative example of an environment in which a flexible gift object is provided in accordance with at least one embodiment;

FIGS. 4A-4D show an illustrative example of an environment in which a recipient of a flexible gift object, through a computing device, scans the flexible gift object in order to activate and assign the flexible gift object to a particular entity in accordance with at least one embodiment;

FIG. 5 shows an illustrative example of an environment in which an assignment recommendation algorithm is dynamically trained to provide recipients of flexible gift objects with assignment recommendations when requesting activation of flexible gift objects in accordance with at least one embodiment;

FIG. 6 shows an illustrative example of a process for generating a flexible gift object for delivery to a particular recipient in accordance with at least one embodiment;

FIG. 7 shows an illustrative example of a process for assigning a flexible gift object to a particular entity in response to a request to activate a flexible gift object in accordance with at least one embodiment; and

FIG. 8 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for generating flexible gift objects that can be provided to intended recipients while allowing the intended recipients to activate the flexible gift objects and to assign the flexible gift objects with specific entities. Through this framework, a gifting distribution service can provide a user with a set of options for defining a particular gift object category for a flexible gift object that is to be given to a particular recipient. The gift object category may be associated with a set of entities to which the flexible gift object can be assigned. The particular recipient receiving the flexible gift object can scan the flexible gift object in order to identify the particular gift object category associated with the flexible gift object and select a particular entity to which the flexible gift object is to be assigned. Upon assignment of the flexible gift object to the selected entity, the flexible gift object is activated, and the particular recipient can use the flexible gift object at point-of-sale locations associated with the selected entity.

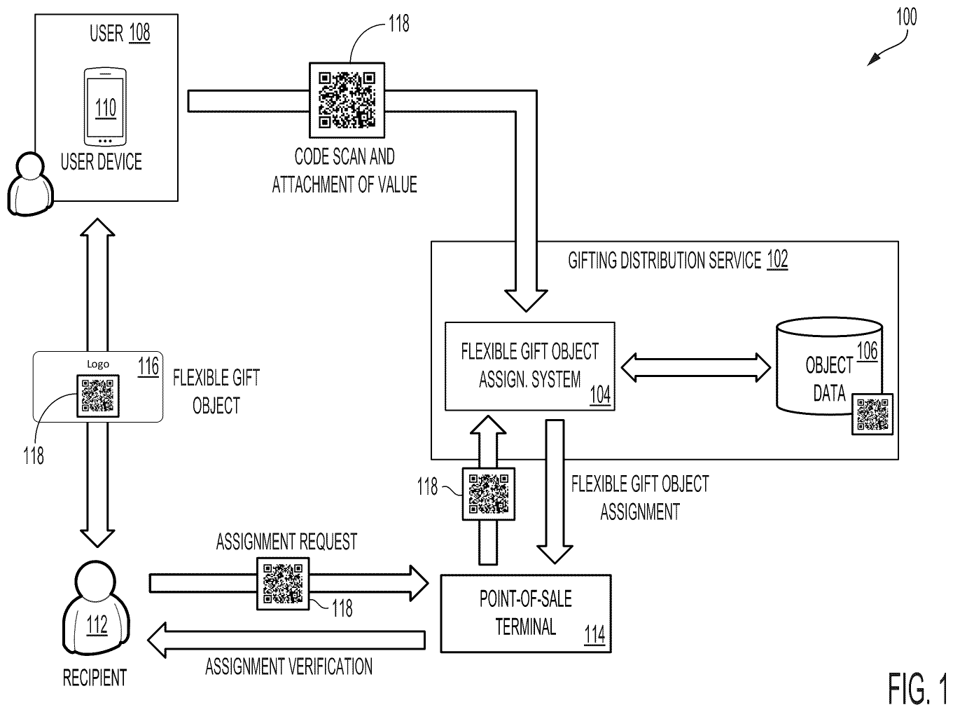

FIG. 1 shows an illustrative example of an environment 100 in which a flexible gift object 116 is generated and provided to a recipient 112 to allow the recipient 112 to select the particular entity to which the flexible gift object 116 is to be assigned upon activation of the flexible gift object 116 in accordance with at least one embodiment. In the environment 100, a user 108, through their user device 110, scans a machine-readable label 118 associated with a flexible gift object 116 to assign a value to the flexible gift object 116 and define a gift object category for the flexible gift object 116. In an embodiment, the flexible gift object 116 is a physical card or other object that includes a machine-readable label 118 that is initially unassigned. For example, data encoded in the machine-readable label 118 may not be associated with a particular monetary value associated with the flexible gift object 116. Further, the data encoded in the machine-readable label 118 may initially not be associated with a particular gift object category corresponding to different entities to which the flexible gift object 116 may be assigned to upon activation, as described in greater detail herein. In some instances, the flexible gift object 116 may have a pre-defined monetary value (e.g., $25, $50, etc.) that is indicated in the data encoded in the machine-readable label 118. The pre-defined monetary value may automatically incorporate a buffer that allows for the flexible gift object 116 to be used for the indicated value. For example, the if the flexible gift object 116 is assigned a $50 value, this $50 value may be reserved for actual purchases as opposed to other purchase-related expenses (e.g., sales taxes, shipping fees, etc.). These purchase-related expenses may be automatically covered by the gifting distribution service 102 and/or by the user 108 that is providing the flexible gift object 116 to a recipient 112. The pre-defined monetary value may not initially be associated with a particular gift object category or entity. In some examples, the flexible gift object 116 may alternatively have a pre-defined value corresponding to units of a cryptocurrency (e.g., Ethereum, Bitcoin, etc.) that, according to an exchange rate keyed to fiat currencies (e.g., U.S. dollar, Euro, Japanese Yen, Chinese Yuan, etc.), may have a fluctuating monetary value.

As illustrated in FIG. 1, the machine-readable label 118 associated with the flexible gift object 116 may be implemented as a Quick Response (QR) code that encodes identifying information associated with the flexible gift object 116, the pre-defined value associated with the flexible gift object 116 (if applicable), and a Uniform Resource Identifier (URI) corresponding to a website that may be used to assist the user 108 in associating the flexible gift object 116 with a particular gift object category. Further, as described in greater detail herein, through this website, the user 108 may define the monetary value associated with the flexible gift object 116 (if not previously pre-defined), as well as provide recipient information associated with the intended recipient of the flexible gift object 116. It should be noted that while QR codes are used extensively throughout the present disclosure for the purpose of illustration, other machine-readable labels may be implemented. For example, the machine-readable label 118 may be implemented using any form of one- or two-dimensional code that can be used to encode information and/or executable instructions (e.g., high capacity color barcodes, NexCode, ShotCode, Qode, Data Matrix, CrontoSign, Aztec Code, barcodes, etc.).

In an embodiment, when the user 108 uses their user device 110 to scan the machine-readable label 118 from the flexible gift object 116, the user device 110 may automatically execute a browser application implemented on the user device 110 to access a gifting distribution service 102 associated with the flexible gift object 116. As noted above, the machine-readable label 118 implemented on the flexible gift object 116 may encode a URI corresponding to a website through which the user 108 may associate the flexible gift object 116 with a particular gift object category. This website may be implemented by the gifting distribution service 102, which may provide a web portal through which the user 108 may associate the flexible gift object 116 with a particular gift object category. Further, if the flexible gift object 116 has not been assigned a monetary value, the gifting distribution service 102 may provide, through the web portal, one or more options for defining the monetary value that is to be assigned to the machine-readable label 118 and, hence, the flexible gift object 116.

In some instances, the gifting distribution service 102 may implement a gifting application that may be installed on the user device 110 and other devices to allow users to define a flexible gift object 116 that can be provided to intended recipients. For example, when the user 108 uses their user device 110 to scan the machine-readable label 118 from the flexible gift object 116, the user device 110 may automatically execute the gifting application implemented on the user device 110. Through the gifting application, the user 108 may access the gifting distribution service 102 to define the flexible gift object 116 that is to be provided to an intended recipient. In some instances, the gifting application may automatically transmit, to the gifting distribution service 102, the data encoded in the machine-readable label 118. This data may include the identifying information associated with the flexible gift object 116 and the pre-defined value associated with the flexible gift object 116, if the flexible gift object 116 has previously been assigned a pre-defined value.

The gifting distribution service 102 may be implemented to allow the user 108 (e.g., a purchaser, a sender, etc.) to generate flexible gift objects that provide recipients an opportunity to define to which entity the flexible gift object is to be assigned. For example, as noted above, the gifting distribution service 102 may implement a gifting application that may be installed on the user device 110 and other devices to allow users to associate a flexible gift object 116 with a particular gift object category to provide intended recipients with one or more options for determining which entity associated with the gift object category the flexible gift object 116 may be assigned to. Additionally, as noted above, the gifting distribution service 102 may implement a web portal or website through which users may access (such as through scanning of a machine-readable label 118 implemented on a flexible gift object 116) the gifting distribution service 102. The user device 110, upon accessing the web portal or website associated with the gifting distribution service 102, may automatically transmit the data encoded in the machine-readable label 118 to the gifting distribution service 102.

In an embodiment, the gifting distribution service 102 implements a flexible gift object assignment system 104 that processes incoming requests to associate unassigned flexible gift objects with a particular gift object category. Further, as described in greater detail herein, the flexible gift object assignment system 104 may further process incoming requests to assign unassigned flexible gift objects to particular entities (e.g., retailers, merchants, etc.) to allow for exclusive use of these flexible gift objects for transactions associated with these particular entities. The flexible gift object assignment system 104 may be implemented as a computer system or application associated with the gifting distribution service 102 to provide the aforementioned functionalities.

In an embodiment, in response to receiving the data encoded in the machine-readable label 118 associated with the flexible gift object 116, the flexible gift object assignment system 104 uses the provided data to query an object datastore 106 to determine whether the machine-readable label 118 can be associated with a particular gift object category. The object datastore 106 may include, for each machine-readable label generated by the gifting distribution service 102 and implemented on a flexible gift object, an entry that defines one or more characteristics associated with the machine-readable label. For example, an entry corresponding to a particular machine-readable label may include a unique identifier associated with the machine-readable label, any monetary value associated with the machine-readable label, an indication as to whether the machine-readable label is assigned to a particular gift object category (and the corresponding gift object category, if so), an indication as to whether the machine-readable label is assigned to a particular entity (and the corresponding entity, if so), an indication as to whether the machine-readable label is associated with a particular recipient (and any available recipient information, if so), and the like.

If the flexible gift object assignment system 104 determines, based on an evaluation of the data associated with the machine-readable label 118, that the machine-readable label 118 is already associated with a particular gift object category or is already assigned to a particular entity through which exclusive use of the flexible gift object 116 has been defined, the flexible gift object assignment system 104 may transmit a notification to the user device 110 to indicate that the flexible gift object cannot be associated with a new gift object category. However, if the flexible gift object assignment system 104 determines that the machine-readable label 118 is not currently associated with a particular gift object category and has not been assigned to a particular entity, the flexible gift object assignment system 104 may provide the user 108, through the user device 110, with one or more options corresponding to different gift object categories that may be associated with the machine-readable label 118. The different gift object categories may correspond to different types of goods and/or services that may be made available through by entities associated with the gifting distribution service 102. For example, the different gift object categories may include, but are not limited to: electronics, toys, restaurants, cafés, home improvement, supermarkets, financial services, coffee, sandwiches, pizza, cryptocurrencies, non-fungible tokens (NFTs), stocks, bonds, mutual funds, and the like.

In an embodiment, each available gift object category is associated with one or more entities that may provide goods and/or services related to the gift object category. As noted above, these entities may correspond to different retailers and merchants that may provide different goods and/or services through point-of-sale locations (e.g., brick-and-mortal storefronts, kiosks, etc.) and/or an online marketplace (e.g., websites, applications, etc.). As an illustrative example, a gift object category corresponding to “coffee” may be associated with one or more coffee vendors that may provide, online and/or through one or more point-of-sale locations, different coffee-related goods and/or services. As another illustrative example, a gift object category corresponding to “restaurants” may be associated with one or more different participating restaurants through which the flexible gift object may be used. However, it should be noted that no gift object category may be directly associated with an individual entity so as to provide recipients of flexible gift objects with an opportunity to assign the flexible gift object to an entity of their choosing.

In an embodiment, the flexible gift object assignment system 104 provides, in response to receiving the data encoded in the machine-readable label 118, a listing or other ordering of the available gift object categories that may be assigned to the machine-readable label 118. For example, if the user 108 is accessing the flexible gift object assignment system 104 through a gifting application implemented on the user device 110, the flexible gift object assignment system 104 may update an interface (e.g., graphical user interface (GUI)) associated with the gifting application to present the available gift object categories for the flexible gift object 116. As another illustrative example, if the user 108 is accessing the flexible gift object assignment system 104 through a website or web portal provided by the gifting distribution service 102, the flexible gift object assignment system 104 may redirect the user 108 (such as through a browser application implemented on the user device 110) to a landing page through which the available gift object categories may be presented.

In some instances, the flexible gift object assignment system 104 may prompt the user 108 to provide identifying information corresponding to an intended recipient 112 of the flexible gift object 116 in order to provide the user 108 with tailored recommendations corresponding to different gift object categories that may be appealing to the intended recipient 112. The identifying information corresponding to a particular recipient 112 may include the recipient's name, the recipient's electronic address, the recipient's physical address, any hobbies that the recipient 112 is interested in, and the like. In some instances, the flexible gift object assignment system 104 may prompt the user to indicate if the flexible gift object 116 is being provided in commemoration of a live event associated with the intended recipient 112 (e.g., birth of a child, a birthday, an anniversary, etc.). Based on the obtained identifying information, the flexible gift object assignment system 104 may automatically construct a recipient profile associated with the intended recipient 112.

In an embodiment, the flexible gift object assignment system 104 implements one or more machine learning algorithms or artificial intelligence that are dynamically trained to provide users with recommendations corresponding to different gift object categories that may be associated with flexible gift objects and that may be appealing to recipients of these flexible gift objects. For instance, the flexible gift object assignment system 104 may implement a clustering algorithm that is dynamically trained to identify similar requests to generate flexible gift objects and similar recipient profiles based on one or more vectors (e.g., demographic information, hobbies, other provided information, etc.). In some embodiments, the flexible gift object assignment system 104 can perform such clustering and obtain partial matches among other recipient profiles and/or flexible gift object requests according to these one or more vectors. In some instances, a dataset of recipient profiles and/or other flexible gift object requests may be analyzed using a clustering algorithm to identify different types of recipient profiles and/or other flexible gift object requests associated with the flexible gift object assignment system 104.

Example clustering algorithms that may trained using sample recipient profiles (e.g., recipient profiles corresponding to historical recipients of flexible gift objects, hypothetical recipient profiles corresponding to hypothetical flexible gift objects, etc.), and/or sample flexible gift object requests (e.g., actual historical flexible gift object requests, hypothetical flexible gift object requests, etc.) datasets to analyze the flexible gift object request and/or the profile of the indicated recipient so as to determine various aspects of the flexible gift object request. The example clustering algorithms may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of these algorithms, the flexible gift object assignment system 104 may determine the various aspects of the flexible gift object request.

In an embodiment, the flexible gift object assignment system 104 can use the obtained identifying information associated with the intended recipient 112 as input to one or more machine learning algorithms or artificial intelligence to generate a set of gift object category recommendations that may be presented to the user 108. This set of gift object category recommendations may correspond to different gift object categories that may be associated with the flexible gift object 116 and that may correspond to different entities. From these different entities, as described in greater detail herein, an intended recipient 112 may select a particular entity that may be assigned to the flexible gift object 116 such that the flexible gift object 116 may only be used for transactions associated with the selected entity.

Once the flexible gift object assignment system 104 has generated one or more gift object category recommendations that may be presented to the user 108, the flexible gift object assignment system 104 may provide, through the user device 110 (such as through the aforementioned gifting application or web portal/website), these one or more gift object category recommendations. For instance, the flexible gift object assignment system 104 may dynamically, and in real-time, update a GUI associated with the gifting application and/or the web portal/website to present the one or more gift object category recommendations through the user device 110. Through the GUI or other interface associated with the gifting application and/or the web portal/website, the user 108 may select a gift object category from the one or more gift object category recommendations to associate the selected gift object category with the flexible gift object 116 that is to be provided to the recipient 112. Based on the user's selection of a particular gift object category, the flexible gift object assignment system 104 may automatically, and in real-time, update the entry corresponding to the machine-readable label 118 implemented on the flexible gift object 116 to associate the machine-readable label 118 with the selected gift object category.

In an embodiment, any selections made by the user 108 in response to the one or more gift object category recommendations can be used to dynamically re-train the one or more machine learning algorithms or artificial intelligence implemented to dynamically, and in real-time, provide gift object category recommendations to users based on any provided recipient information. For example, if the flexible gift object assignment system 104 generates, based on a particular cluster identified by the one or more machine learning algorithms or artificial intelligence, one or more gift object category recommendations corresponding to automotive parts, but the user selects a gift object category corresponding to coffee or other food-related products, the flexible gift object assignment system 104 may use this selection of an alternative gift object category as negative feedback indicative of a need to adjust or otherwise modify the one or more vectors and corresponding clusters maintained by the one or more machine learning algorithms or artificial intelligence such that the recipient 112, and other similarly-situated recipients are assigned similar classifications or clusters. Alternatively, if the flexible gift object assignment system 104 generates, based on a particular cluster identified by the one or more machine learning algorithms or artificial intelligence, one or more gift object category recommendations corresponding to baby products, and the user selects a particular gift object category corresponding to the provided one or more gift object category recommendations, the flexible gift object assignment system 104 may use this selection of a gift object category corresponding to baby products as positive feedback indicative of the present accuracy of the one or more vectors and corresponding clusters. This positive feedback may thus be used to further reinforce the one or more machine learning algorithms or artificial intelligence.

Based on the user's selection of a particular gift object category for the flexible gift object 116, the flexible gift object assignment system 104 may associate the particular gift object category with the machine-readable label 118 associated with the flexible gift object 116. For instance, the flexible gift object assignment system 104 may dynamically update the entry corresponding to the machine-readable label 118 associated with the flexible gift object 116 to indicate that the machine-readable label 118 is now associated with the selected gift object category. In some instances, the flexible gift object assignment system 104 may further update this entry to associate the machine-readable label 118 with the user 108. This may allow the recipient 112 of the flexible gift object 116 to identify the user 108 as the sender of the flexible gift object 116 when the recipient 112 scans the machine-readable label 118, as described in greater detail herein. The flexible gift object assignment system 104 may provide the user 108 with a confirmation that the flexible gift object 116 is now associated with a particular gift object category and a particular value (as defined by the user 108 or pre-defined by the gifting distribution service 102). This may serve as an indication to the user 108 that the flexible gift object 116 may now be gifted to an intended recipient, such as recipient 112.

The recipient 112, upon receiving the flexible gift object 116, may scan the machine-readable label 118 implemented on the flexible gift object 116 to begin an activation and assignment process for the flexible gift object 116. For example, as illustrated in FIG. 1, the recipient 112 may scan the machine-readable label 118 associated with the flexible gift object 116 using a point-of-sale terminal 114. The point-of-sale terminal 114 may be associated with a particular retailer or merchant. As noted above, the machine-readable label 118 may encode a URI corresponding to a website or web portal associated with the gifting distribution service 102. In some instances, the machine-readable label 118 may further encode a network address (e.g., Internet Protocol (IP) address, Media Access Control (MAC) address, etc.) associated with the gifting distribution service 102. Using this encoded data, the point-of-sale terminal 114 may transmit a request to the flexible gift object assignment system 104 to determine whether the flexible gift object 116 can be assigned to the retailer or merchant associated with the point-of-sale terminal 114. The request may include the encoded data extracted from the machine-readable label 118.

In response to the request from the point-of-sale terminal 114, the flexible gift object assignment system 104 may use the received encoded data to query the object datastore 106 to identify the entry corresponding to the machine-readable label 118. As noted above, the encoded data may include a unique identifier associated with the machine-readable label 118. Accordingly, the flexible gift object assignment system 104 may query the object datastore 106 to identify an entry corresponding to this unique identifier. If the flexible gift object assignment system 104 identifies an entry corresponding to the unique identifier and, hence, the machine-readable label 118, the flexible gift object assignment system 104 may evaluate the entry in real-time to determine whether the flexible gift object 116 may be assigned to the retailer associated with the point-of-sale terminal 114. For example, if the machine-readable label 118 is currently assigned to another retailer such that use of the flexible gift object 116 is limited to transactions associated with this other retailer, the flexible gift object assignment system 104 may determine that the flexible gift object 116 may not be assigned to the retailer associated with the point-of-sale terminal 114. As another illustrative example, if the flexible gift object assignment system 104 determines that the flexible gift object 116 has not been assigned to a particular retailer or merchant but is otherwise associated with a selected gift object category, the flexible gift object assignment system 104 may determine whether the retailer associated with the point-of-sale terminal 114 corresponds to the selected gift object category. For instance, if the point-of-sale terminal 114 is associated with an automotive parts supplier but the gift object category associated with the flexible gift object 116 corresponds to baby products, the flexible gift object assignment system 104 may determine that the flexible gift object 116 cannot be assigned to the automotive parts supplier. However, if the point-of-sale terminal 114 is associated with a retailer that sells clothing and other supplies for infants and children, the flexible gift object assignment system 104 may determine that the flexible gift object 116 may be assigned to the particular retailer.

If the flexible gift object assignment system 104 determines that the flexible gift object 116 may be assigned to the particular retailer associated with the point-of-sale terminal 114, the flexible gift object assignment system 104 may transmit a request or instruction to the point-of-sale terminal 114 to prompt the recipient 112 for verification of the assignment of the flexible gift object 116 to this retailer. In response to the request or instruction, the point-of-sale terminal 114 (such as through a display element or GUI implemented on the point-of-sale terminal 114) may prompt the recipient 112 to verify that they would like to have the flexible gift object 116 assigned to the particular retailer for exclusive use in transactions associated with the retailer. If the recipient 112 verifies that the flexible gift object 116 is to be assigned for use with the particular retailer, the point-of-sale terminal 114 may provide the recipient's verification to the flexible gift object assignment system 104. In response to this verification, the flexible gift object assignment system 104 may update the entry corresponding to the machine-readable label 118 implemented on the flexible gift object 116 to indicate that the machine-readable label 118 is now assigned to the particular retailer. Thus, if the recipient 112 attempts to use the flexible gift object 116 for transactions not associated with the particular retailer, the transactions may be rejected, as the flexible gift object 116 is assigned for use exclusively with the particular retailer. As described in greater detail herein, while the recipient 112 may assign the flexible gift object 116 to a particular retailer through a point-of-sale terminal 114, the recipient 112 may later submit a request to the flexible gift object assignment system 104 to re-assign the flexible gift object 116 to another retailer corresponding to the gift object category associated with the flexible gift object 116. Thus, unlike closed loop gift objects whereby these gift objects are restricted to specific retailers, the flexible gift object 116 may be re-assigned to other retailers at any time by the recipient 112.

In an embodiment, the recipient 112 can activate the flexible gift object 116 for use with a particular retailer or merchant through their own computing device. For example, the recipient 112 may use their own computing device to scan the machine-readable label 118 in order to submit an activation request to the flexible gift object assignment system 104. As noted above, the machine-readable label 118 implemented on the flexible gift object 116 may encode a URI corresponding to a website or web portal associated with the gifting distribution service 102. In some instances, if the recipient 112 implements the aforementioned gifting application on their computing device, when the recipient 112 uses their computing device to scan the machine-readable label 118 from the flexible gift object 116, the computing device may automatically execute the gifting application. Through the gifting application, the recipient 112 may access the gifting distribution service 102 to activate the flexible gift object 116. In some instances, the gifting application may automatically transmit, to the gifting distribution service 102, the data encoded in the machine-readable label 118. This data may include the unique identifier associated with the machine-readable label 118, as described above.

In response to receiving the encoded data associated with the machine-readable label 118 implemented on the flexible gift object 116, the flexible gift object assignment system 104 may query the object datastore 106 to identify an entry corresponding to the machine-readable label 118. Through this entry, the flexible gift object assignment system 104 may determine whether the machine-readable label 118 and, hence, the flexible gift object is already assigned to a particular retailer or merchant. Further, from this entry, the flexible gift object assignment system 104 may determine the value assigned to the flexible gift object 116 (as defined by the user 108 or pre-defined by the gifting distribution service 102 upon purchase of the flexible gift object 116). In some instances, the entry corresponding to the machine-readable label 118 may include identifying information associated with the user 108 that has provided the flexible gift object 116 to the recipient 112. The identifying information may include the name of the user 108, a physical address associated with the user 108, an electronic mail address associated with the user 108, and the like. In some instances, the entry may include any custom messages or greetings defined by the user 108 when associating the flexible gift object 116 with a particular gift object category. For example, the user 108 may provide a custom message that states, “Congratulations on your promotion!,” “Happy Birthday!,” or any other greeting that may be germane to the purpose for which the flexible gift object 116 is being given to the recipient 112. This custom message may be provided to the recipient 112 through their computing device (such as through the gifting application or other application used to access the flexible gift object assignment system 104).

In an embodiment, if the machine-readable label 118 has not been assigned to a particular retailer or merchant but is otherwise associated with a particular gift object category, the flexible gift object assignment system 104 may identify a set of retailers and merchants that are associated with the particular gift object category. As an illustrative example, if the particular gift object category corresponds to baby products or other baby-related goods and services, the flexible gift object assignment system 104 may automatically, and in real-time, identify any retailers and merchants that may provide baby-related goods and services. These retailers and merchants may have pre-existing relationships with the gifting distribution service 102 and may provide information corresponding to the goods and/or services that they provide. This information may be used by the gifting distribution service 102 to categorize each of these retailers and merchants along different gift object categories. This may allow the flexible gift object assignment system 104 to automatically, and in real-time, identify the retailers and merchants that may be associated with an indicated gift object category. In some instances, the gifting distribution service 102 may associate different retailers and merchants with the different gift object categories regardless of whether these retailers and merchants have an existing relationship with the gifting distribution service 102 or not. For example, the gifting distribution service 102 may interact with one or more financial institutions, retailer systems, credit reporting agencies, consumer organizations, and the like to obtain information corresponding to the goods and/or services that may be provided by different retailers and merchants that may be used to categorize these retailers and merchants along the different gift object categories.

In an embodiment, based on the identified gift object category associated with the flexible gift object 116, the flexible gift object assignment system 104 may provide the recipient 112 with one or more recommendations corresponding to one or more particular retailers or merchants that may be desirable to the recipient 112 for assignment of the flexible gift object 116. For example, in an embodiment, the flexible gift object assignment system 104 may use identifying information associated with the recipient 112 (as provided by the user 108 or the recipient 112), any available historical information associated with the recipient 112 (e.g., past purchase histories, past gift redemption histories, etc.), and the gift object category associated with the flexible gift object 116 as input to one or more machine learning algorithms or artificial intelligence dynamically trained to generate assignment recommendations to recipients, such as recipient 112. In some instances, the flexible gift object assignment system 104 may implement a clustering algorithm that is dynamically trained to generate assignment recommendations for different recipients of flexible gift objects according to any known information associated with these recipients and the gift object categories associated with corresponding flexible gift objects.

The clustering algorithm implemented by the flexible gift object assignment system 104 may be dynamically trained to identify similar recipients and flexible gift objects based on one or more vectors (e.g., demographic information, recipient interests, event or purpose for gifting of the flexible gift objects, historical information associated with the recipients, monetary value associated with the flexible gift objects, etc.). In some embodiments, the flexible gift object assignment system 104 can perform such clustering and obtain partial matches among other recipient profiles and/or other flexible gift objects according to these one or more vectors. In some instances, a dataset of recipient profiles and/or other flexible gift objects may be analyzed using a clustering algorithm identify different types of recipient profiles and/or flexible gift objects associated with the flexible gift object assignment system 104. The clustering algorithm may be dynamically trained using sample recipient profiles (e.g., recipient profiles corresponding to historical recipients of flexible gift objects, hypothetical recipient profiles corresponding to hypothetical flexible gift objects, etc.) and/or sample flexible gift objects (e.g., actual historical flexible gift objects and corresponding assignments, hypothetical flexible gift objects and corresponding hypothetical assignments, etc.) that may be included in one or more datasets. These one or more datasets may be used to dynamically train the clustering algorithm to analyze a recipient profile associated with the recipient 112 and/or the characteristics of the flexible gift object 116 (e.g., gift object category associated with the flexible gift object 116, the monetary value assigned to the flexible gift object 116, information corresponding to the user 108 that generated the flexible gift object 116, recipient information provided by the user 108, any custom messages provided by the user 108 for the flexible gift object 116, etc.) to generate one or more assignment recommendations that may be provided to the recipient 112 for assignment of the flexible gift object 116 to a particular retailer or merchant.

In some instances, the flexible gift object assignment system 104 may prompt the recipient 112 for additional information that may be used to provide the recipient 112 with tailored assignment recommendations for their flexible gift object 116. For example, the flexible gift object assignment system 104 may prompt the recipient 112 to provide identifying information corresponding to the recipient 112 (e.g., name, physical address, electronic mail address, etc.) that may be used by the flexible gift object assignment system 104 to determine whether an existing recipient profile associated with the recipient 112 is available for evaluation. For instance, if the recipient 112 has previously received flexible gift objects from other users and has assigned these flexible gift objects to different retailers and/or merchants, the flexible gift object assignment system 104 may use the provided recipient information to identify a recipient profile that includes historical data corresponding to these previously received flexible gift objects and corresponding assignments. Further, from the recipient profile, the flexible gift object assignment system 104 may discern any recipient interests, hobbies, life events, and the like that may be used to inform (using the aforementioned one or more machine learning algorithms or artificial intelligence) what retailers and/or merchants associated with the selected gift object category may be of interest to the recipient 112. In some instances, the recipient profile may include historical information corresponding to recipient purchases made through different retailers and/or merchants that may be used to identify any favored retailers and/or merchants that the recipient 112 may often frequent. Through evaluation of this historical information, the flexible gift object assignment system 104 may generate one or more assignment recommendations that include any favored retailers and/or merchants that correspond to the selected gift object category associated with the flexible gift object 116.

In an embodiment, the flexible gift object assignment system 104 uses any available location information associated with the recipient 112 to identify different retailers and/or merchants that may be recommended to the recipient 112 according to the assigned gift object category. For instance, using the aforementioned one or more machine learning algorithms or artificial intelligence, the flexible gift object assignment system 104 may process the recipient's physical address or any other indicated location (e.g., an address other than the physical address corresponding to the recipient's home, etc.), to identify different merchants and/or retailers that are associated with the assigned gift object category and that may be located within proximity of the identified recipient location (e.g., within 5 miles of the location, within 10 miles of the location, etc.). In some instances, the identified recipient location may be used with any other identifying information corresponding to the recipient 112 to further narrow the list of recipients and/or merchants that may be provided to the recipient 112 as selection options for assignment of the flexible gift object 116. For instance, if the flexible gift object assignment system 104, through the aforementioned one or more machine learning algorithms or artificial intelligence, identifies any favored retailers and/or merchants that the recipient 112 may often frequent, the flexible gift object assignment system 104 may use the identified recipient location to identify any local or proximate points-of-sale associated with these favored retailers and/or merchants that may be recommended to the recipient 112. For example, if the recipient 112 often frequents a particular automotive parts retailer, the flexible gift object assignment system 104 may use the recipient's location to identify a point-of-sale associated with this particular automotive parts retailer that may be local or proximate to the recipient 112 based on this location. Accordingly, the recommendations provided by the flexible gift object assignment system 104 may correspond to particular points-of-sale associated with favored retailers and/or merchants corresponding to the gift object category assigned to the flexible gift object 116.

In an embodiment, the flexible gift object assignment system 104 provides to the recipient 112 a set of selection options corresponding to different retailers and/or merchants to which the flexible gift object 116 may be assigned. For instance, if the recipient 112 accesses the gifting distribution service 102 through a gifting application implemented on the recipient's computing device, the flexible gift object assignment system 104 may automatically, and in real-time, update an interface associated with the gifting application to present this set of selection options. As another illustrative example, if the recipient 112 accesses the gifting distribution service 102 through a website or web portal associated with the gifting distribution service 102, the flexible gift object assignment system 104 may redirect the recipient 112 to a landing page associated with the gifting distribution service 102, through which the recipient 112 may be presented with this set of selection options.

In an embodiment, the set of selection options are sorted according to the determined likelihood of the recipient 112 selecting a corresponding option. For example, any selection options corresponding to the assignment recommendations generated by the flexible gift object assignment system 104 may be prioritized over other selection options corresponding to the gift object category associated with the flexible gift object 116. As another example, the set of selection options may be ordered according to the known frequency at which the recipient 112 has purchased goods and/or services from the different retailers and/or merchants associated with the set of selection options. In some instances, the set of selection options may be alternatively sorted according to one or more other criteria. For example, the set of selection options may be ordered alphabetically. As another example, the set of selection options may be ordered according to the proximity between the recipient's physical address and point-of-sale locations associated with the myriad retailers and/or merchants associated with the gift object category associated with the flexible gift object 116.

In an embodiment, if the recipient 112 selects, from the presented set of selection options, a particular retailer or merchant to whom the flexible gift object 116 is to be assigned, the flexible gift object assignment system 104 updates the entry corresponding to the machine-readable label 118 implemented on the flexible gift object 116 to assign the machine-readable label to the particular retailer or merchant. For instance, the flexible gift object assignment system 104 may update the entry corresponding to the machine-readable label 118 to replace the association between the machine-readable label 118 and the previously selected gift object category with an indication of the assignment of the machine-readable label 118 to the selected retailer or merchant. Through this update of the entry corresponding to the machine-readable label 118, the flexible gift object assignment system 104 may automatically assign the flexible gift object 116 to the selected retailer or merchant such that the flexible gift object 116 may only be used for transactions associated with the selected retailer or merchant.

In an embodiment, once the assignment has been completed, the flexible gift object assignment system 104 may transmit data corresponding to the machine-readable label 118 to one or more retailer systems associated with the selected retailer or merchant to allow the selected retailer or merchant to process transactions associated with the flexible gift object 116. The data may include the unique identifier corresponding to the machine-readable label 118 and the monetary amount associated with the machine-readable label 118 and the flexible gift object 116. This may allow the retailer or merchant to process transactions involving the flexible gift object 116 locally (such as through a point-of-sale terminal 114 associated with the retailer or merchant) without requiring access to the gifting distribution service 102 for processing the transaction.

If the flexible gift object assignment system 104 generated, through one or more machine learning algorithms or artificial intelligence, one or more assignment recommendations that were presented to the recipient 112 prior to assignment of a particular retailer or merchant to the flexible gift object 116, the flexible gift object assignment system 104 may use the recipient's selection of a particular retailer or merchant as feedback that may be used to dynamically, and in real-time, update the one or more machine learning algorithms or artificial intelligence. For instance, if the flexible gift object assignment system 104 generates, based on a particular cluster identified by the one or more machine learning algorithms or artificial intelligence, one or more assignment recommendations corresponding to retailers that do not have point-of-sale locations near the recipient 112 and/or that the recipient 112 has no history of frequenting (whether physically or online), and the recipient 112 selects a different retailer that was not recommended by the flexible gift object assignment system 104, the flexible gift object assignment system 104 may use this alternative selection of this different retailer as negative feedback that is indicative of a need to adjust or otherwise modify the one or more vectors and corresponding clusters maintained by the one or more machine learning algorithms or artificial intelligence such that the recipient 112, and other similarly-situated recipients (e.g., recipients receiving flexible gift objects associated with similar gift object categories, recipients having similar purchase histories, recipients having similar interests or life events, etc.) are assigned similar classifications or clusters. Alternatively, if the flexible gift object assignment system 104 generates, based on a particular cluster identified by the one or more machine learning algorithms or artificial intelligence, one or more assignment recommendations corresponding to retailers that the recipient 112 is known to frequent and/or have point-of-sale locations near the recipient 112, and the recipient 112 selects a retailer associated with the one or more assignment recommendations, the flexible gift object assignment system 104 may use this selection of this retailer as positive feedback indicative of the present accuracy of the one or more vectors and corresponding clusters. This positive feedback may thus be used to further reinforce the one or more machine learning algorithms or artificial intelligence.

Once the flexible gift object 116 has been assigned to a particular retailer, merchant, or other entity through which transactions may be performed using the flexible gift object 116, the flexible gift object assignment system 104 may provide the recipient 112 with an assignment verification to indicate that the flexible gift object 116 has been activated for use in transactions associated with the particular retailer, merchant, or other entity. The recipient 112 may proceed to use the flexible gift object 116 at point-of-sale locations and at online marketplaces associated with the particular retailer, merchant, or other entity to whom the flexible gift object 116 is assigned. If the recipient 112 attempts to use the flexible gift object 116 for transactions associated with other retailers, merchants, or entities that are not assigned to the flexible gift object 116, these transactions may be automatically declined. As noted above, once the assignment has been completed, the flexible gift object assignment system 104 may transmit data corresponding to the machine-readable label 118 to one or more retailer systems associated with the selected retailer or merchant to allow the selected retailer or merchant to process transactions associated with the flexible gift object 116. Since other retailers, merchants, and other entities other than the selected retailer or merchant may not have access to this data, these other retailers, merchants, and other entities may be unable to process transactions using the flexible gift object 116, as the machine-readable label 118 associated with the flexible gift object 116 may be unrecognizable or unknown to these other retailers, merchants, and other entities.

In an embodiment, the flexible gift object assignment system 104 monitors, in real-time, new data associated with the recipient 112 to dynamically determine whether to recommend a re-assignment of the flexible gift object 116 to another retailer or merchant associated with the gift object category associated with the flexible gift object 116. As an illustrative example, the flexible gift object assignment system 104 may automatically, and in real-time, obtain location data corresponding to the recipient 112, such as through a gifting application or other application implemented on the recipient's computing device. The location data may include Global Positioning System (GPS) location data, Internet Protocol (IP)-based geolocation data, Wi-Fi positioning data, cellular trilateration data, and the like. The flexible gift object assignment system 104 may use the obtained location data in real-time to determine whether to provide the recipient 112 with a recommendation to re-assign the flexible gift object 116 to another retailer or merchant. For instance, if the flexible gift object assignment system 104 determines that the recipient 112 has been at a location for a threshold period of time (e.g., a week, two week, a month, etc.) where the retailer or merchant assigned to the flexible gift object 116 does not maintain a point-of-sale location or otherwise does not maintain a presence at the location, the flexible gift object assignment system 104 may use the aforementioned one or more machine learning algorithms or artificial intelligence to identify other retailers or merchants that may be recommended to the recipient 112 for re-assignment of the flexible gift object 116. Based on these new assignment recommendations, the recipient 112 may opt to re-assign the flexible gift object 116 to another retailer or merchant or to maintain the assignment of the flexible gift object 116 with the current retailer or merchant. The recipient's response to the new assignment recommendations may be used to update the one or more machine learning algorithms or artificial intelligence, similar to the process described above.

In an embodiment, the flexible gift object assignment system 104 further monitors, in real-time, transaction data corresponding to the flexible gift object 116 and transaction data associated with the recipient 112 in order to determine whether to generate one or more new assignment recommendations for the recipient 112. For example, if the flexible gift object assignment system 104 determines, based on the transaction data corresponding to the flexible gift object 116, that the flexible gift object 116 has not been used for transactions associated with the assigned retailer or merchant for a pre-defined period of time (e.g., a week, two weeks, a month, etc.), the flexible gift object assignment system 104 may provide the recipient 112 with one or more new assignment recommendations corresponding to other retailers and/or merchants that the recipient 112 may re-assign the flexible gift object 116 to. The flexible gift object assignment system 104 may use the aforementioned one or more machine learning algorithms or artificial intelligence to identify these other retailers or merchants that may be recommended to the recipient 112 for re-assignment of the flexible gift object 116. Based on these new assignment recommendations, the recipient 112 may opt to re-assign the flexible gift object 116 to another retailer or merchant or to maintain the assignment of the flexible gift object 116 with the current retailer or merchant.

In an embodiment, the gifting distribution service 102 is associated with one or more other entities that may maintain transaction data corresponding to the recipient 112. For example, the gifting distribution service 102 may be associated with a financial institution that provides different credit and/or payment instruments to consumers, such as recipient 112. If the financial institution maintains an account associated with the recipient 112, the flexible gift object assignment system 104 may obtain, in real-time, transaction data from the account. The flexible gift object assignment system 104 may evaluate the transaction data to identify any spending trends associated with the recipient 112 including, but not limited to, the frequency at which the recipient 112 may engage in transactions with different retailer and/or merchants over time. In an embodiment, if the flexible gift object assignment system 104 determines that the recipient 112 has not used their flexible gift object 116 over a threshold period of time for transactions associated with the assigned retailer or merchant, the flexible gift object assignment system 104 may use the identified spending trends associated with the recipient 112 to determine whether to generate one or more new assignment recommendations according to the gift object category associated with the flexible gift object 116. The flexible gift object assignment system 104 may generate these one or more new assignment recommendations using the aforementioned one or more machine learning algorithms or artificial intelligence, as described above.

In some instances, the recipient 112 can submit a request to the flexible gift object assignment system 104 to re-assign the flexible gift object 116 to another retailer, merchant, or other entity for use in transactions associated with this other retailer, merchant, or other entity. For example, the recipient 112, using their computing device, may scan the machine-readable label 118 associated with the flexible gift object 116 to access the flexible gift object assignment system 104 and to provide the data encoded in the machine-readable label 118. In response to obtaining this data, the flexible gift object assignment system 104 may query the object datastore 106 to identify the current assignment associated with the flexible gift object 116. The flexible gift object assignment system 104 may provide information to the recipient 112 corresponding to the present assignment associated with the flexible gift object 116. Further, the flexible gift object assignment system 104 may provide the recipient 112 with one or more options for re-assigning the flexible gift object 116 to another retailer, merchant, or entity associated with the gift object category associated with the flexible gift object 116. These one or more options, in an embodiment, can be generated using the aforementioned one or more machine learning algorithms or artificial intelligence, as described above. For instance, the one or more options may be provided based on newly generated assignment recommendations corresponding to other retailers, merchants, or entities that may be appealing to the recipient 112 for assignment to the flexible gift object 116.

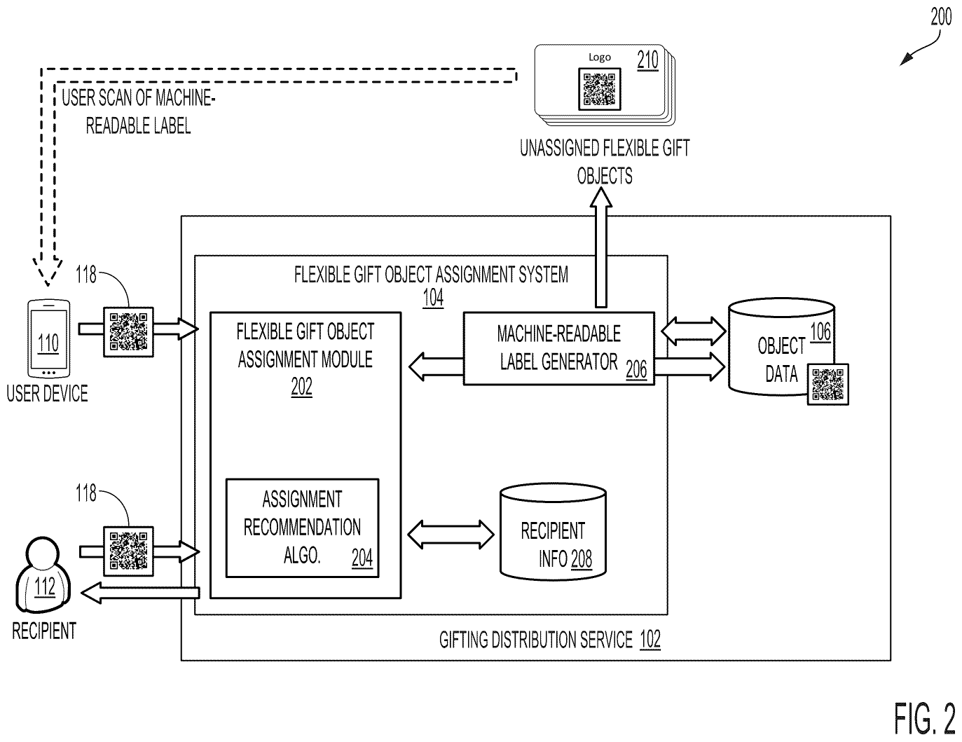

FIG. 2 shows an illustrative example of an environment 200 in which a flexible gift object is generated and associated with a machine-readable label 118 through which the flexible gift object can be assigned to a particular entity upon activation of the flexible gift object in accordance with at least one embodiment. In the environment 200, the gifting distribution service 102, through the flexible gift object assignment system 104, may implement a machine-readable label generator 206 that may generate unique machine-readable labels that may be implemented on unassigned flexible gift objects 210. The machine-readable label generator 206 may be implemented as a computer system or application associated with the flexible gift object assignment system 104. Each unique machine-readable label generated by the machine-readable label generator 206 may be associated with a unique identifier that may be encoded into the machine-readable label. Further, if a machine-readable label is to be associated with a pre-determined monetary value, the machine-readable label generator 206 may further encode this pre-determined monetary value into the machine-readable label. As the machine-readable label generator 206 generates new machine-readable labels, the machine-readable label generator 206 may provide these new machine-readable labels to another entity (e.g., a printer, a gift card manufacturer, etc.) to implement these new machine-readable labels on unassigned flexible gift objects 210. This may allow users to obtain unassigned flexible gift objects 210 in order to request association of these unassigned flexible gift objects 210 to particular gift object categories, as described above.

In an embodiment, the machine-readable label generator 206 encodes, on each machine-readable label generated for implementation on a flexible gift object, a URI corresponding to a website or web portal through which users may associate a flexible gift object with a particular gift category, assign a monetary value to the flexible gift object, provide recipient information that may be used to dynamically provide the user and the recipient with various tailored recommendations for the flexible gift object, and the like. Additionally, or alternatively, the machine-readable label generator 206 may further encode, onto a machine-readable label, executable instructions that, when processed and executed by a computing device upon scanning of the machine-readable label, may cause the computing device to execute a gifting application implemented on the computing device. The gifting application may be associated with the gifting distribution service 102 and may provide the computing device with access to the flexible gift object assignment system 104 through one or more application programming interfaces (APIs). In some instances, if the computing device does not implement the gifting application, the executable instructions may cause the computing device to download or otherwise obtain and install the gifting application. Alternatively, if the computing device does not implement the gifting application but the data encoded on the machine-readable label includes a URI corresponding to the website or web portal associated with the gifting distribution service 102, the computing device may execute a browser application implemented on the computing device and use the URI to access this website or web portal.

In some instances, the unassigned flexible gift objects 210 may, by default, be assigned with a particular gift object category. For example, particular unassigned flexible gift objects 210 may be associated with a “coffee” gift object category, whereby these unassigned flexible gift objects 210 may, by default, be limited for use for transactions involving coffee-related purchases. As another example, particular unassigned flexible gift objects 210 may be associated with a “baby shower” gift object category, whereby these unassigned flexible gift objects 210 may, by default, be limited for use for transactions involving baby-related purchases from retailers and merchants that sell clothing and other supplies for infants and children. For these particular unassigned flexible gift objects 210, the machine-readable label generator 206 may associate the data encoded in the machine-readable labels implemented on these particular unassigned flexible gift objects 210 to pre-defined gift object category.

As the machine-readable label generator 206 generates a new machine-readable label for a new unassigned flexible gift object 210, the machine-readable label generator 206 may create a new entry corresponding to this new machine-readable label in the object datastore 106. This new entry may be used to define one or more characteristics associated with the machine-readable label. For example, within the entry corresponding to a particular machine-readable label, the machine-readable label generator 206 may include a unique identifier associated with the machine-readable label, any pre-defined monetary value associated with the machine-readable label, an indication as to whether the machine-readable label is assigned to a particular gift object category (and the corresponding gift object category, if so), and the like. As noted above, the machine-readable label may encode data that may be used to uniquely identify the machine-readable label and the flexible gift object that implements the machine-readable label. Thus, using this data, the flexible gift object assignment system 104 may be able to query the object datastore 106 to identify the entry corresponding to this machine-readable label.

In an embodiment, a user, through their user device 110, can scan a machine-readable label 118 associated with an unassigned flexible gift object 210 to make the flexible gift object available for activation. For example, when the user, through their user device 110, scans the machine-readable label 118 implemented on an unassigned flexible gift object 210, the user may be re-directed to the flexible gift object assignment system 104 associated with the gifting distribution service 102 to perform an initial assignment of the unassigned flexible gift object 210. For example, if the machine-readable label 118 encodes a URI corresponding to the gifting distribution service 102, the user device 110 may automatically execute a browser application implemented on the user device 110 and use the encoded URI to access the gifting distribution service 102. Alternatively, if the machine-readable label 118 encodes executable instructions that, when executed by the user device 110, may cause the user device 110 to execute a gifting application associated with the gifting distribution service 102, the user device 110 may process these executable instructions to determine if the user device 110 implements the gifting application and, if so, may execute these executable instructions to initiate the gifting application on the user device 110. Alternatively, if the user device 110 does not implement the gifting application, the user device 110 may automatically obtain the gifting application from the gifting distribution service 102 (such as through a network location through which the gifting application is made available) and install the gifting application on the user device 110 for execution of the gifting application.

As noted above, the gifting distribution service 102 may implement a flexible gift object assignment system 104 that processes incoming requests to associate unassigned flexible gift objects with a particular gift object category. Further, as described in greater detail herein, the flexible gift object assignment system 104 may further process incoming requests to assign unassigned flexible gift objects to particular entities (e.g., retailers, merchants, etc.) to allow for exclusive use of these flexible gift objects for transactions associated with these particular entities. In some instances, if an unassigned flexible gift object is, by default, assigned to a particular gift object category, the flexible gift object assignment system 104 may allow users to provide identifying information associated with an intended recipient of the flexible gift object. As described herein, this identifying information may be used to dynamically generate assignment recommendations for the intended recipient when the intended recipient submits a request to activate the flexible gift object.

In an embodiment, and as illustrated in FIG. 2, the flexible gift object assignment system 104 may implement a flexible gift object assignment module 202, which may be implemented to process incoming requests from users looking to define a flexible gift object for delivery to a recipient. Further, the flexible gift object assignment module 202 may be implemented to process incoming requests from recipients of flexible gift objects to assign these flexible gift objects to particular entities such that these flexible gift objects may only be used for transactions associated with these particular entities. The flexible gift object assignment module 202, in an embodiment, is implemented on a special purpose computing device or system that is configured to process these incoming requests and automatically update entries associated with machine-readable labels associated with different flexible gift objects to associate these flexible gift objects to particular gift object categories and to assign these flexible gift objects to particular entities according to the corresponding gift object categories associated with these flexible gift objects. Further, as described in greater detail herein, this special purpose computing device or system may implement one or more machine learning algorithms or artificial intelligence (such as the assignment recommendation algorithm 204) to provide users and recipients with tailored recommendations corresponding to possible gift object categories and corresponding entities that may be associated and assigned to a particular flexible gift object.

The flexible gift object assignment module 202 may receive data encoded on a machine-readable label 118 associated with a particular flexible gift object from a user device 110 at any time. For instance, if the user uses their user device 110 to scan the machine-readable label 118, resulting in execution of a gifting application implemented on the user device 110, the gifting application, through one or more APIs, may automatically transmit the data encoded on the machine-readable label 118 to the flexible gift object assignment module 202. Alternatively, if the data encoded on the machine-readable label 118 causes the user device 110 to execute a browser application and use a URI encoded on the machine-readable label 118 to access a website or web portal associated with the gifting distribution service 102, the browser application may automatically pass the data encoded on the machine-readable label 118 to the flexible gift object assignment module 202 through the website or web portal.

In response to receiving the data encoded in the machine-readable label 118, the flexible gift object assignment module 202 may query the object datastore 106 to identify an entry corresponding to the machine-readable label 118. As noted above, the machine-readable label generator 206 may create an entry for each machine-readable label that is implemented on an unassigned flexible gift object 210. This entry may be keyed according to the unique identifier associated with the corresponding machine-readable label such that, in response to a query including a unique identifier corresponding to the machine-readable label, the flexible gift object assignment module 202 may be able to identify the entry corresponding to the machine-readable label from the object datastore 106.

In an embodiment, the flexible gift object assignment module 202 evaluates the entry corresponding to the machine-readable label 118 to determine whether the machine-readable label 118 is already associated with a particular gift object category and/or is already assigned to a particular entity for exclusive use with that particular entity. If the flexible gift object assignment module 202 determines that the machine-readable label 118 is already assigned to a particular entity for exclusive use with that particular entity, the flexible gift object assignment module 202 may indicate that the flexible gift object cannot be associated with a gift object category, as the flexible gift object has already been activated for use with the particular entity. In an embodiment, if the flexible gift object assignment module 202 determines that the machine-readable label 118 is already associated with a flexible gift object, as pre-defined by the gifting distribution service 102 or as defined by a user (e.g., the user associated with the user device 110, another user, etc.), the flexible gift object assignment module 202 may indicate that the flexible gift object has already been associated with a particular gift object category and, thus, prevent the user from changing the gift object category associated with the flexible gift object. In some instances, if the flexible gift object assignment module 202 determines that the flexible gift object was associated with a particular gift object category by the user associated with the user device 110, and the flexible gift card has not been activated by a recipient 112, the flexible gift object assignment module 202 may allow the user to associate the flexible gift object to another gift object category.

If the flexible gift object assignment module 202 determines that the machine-readable label 118 is not currently associated with a particular gift object category and has not been assigned to a particular entity, the flexible gift object assignment module 202 may provide a user, through the user device 110, with one or more options corresponding to different gift object categories that may be associated with the machine-readable label 118. The one or more options provided to the user device 110 by the flexible gift object assignment module 202 may be organized in the form of a listing or other ordering of the available gift object categories that may be assigned to the machine-readable label 118. As noted above, the different gift object categories may correspond to different types of goods and/or services that may be made available by entities associated with the gifting distribution service 102. Further, the different gift object categories may correspond to different types of entities (retailer, merchants, etc.) according to the types of goods and/or services provided by these entities. These entities may provide different goods and/or services through point-of-sale locations (e.g., brick-and-mortal storefronts, kiosks, etc.) and/or online marketplaces (e.g., websites, applications, etc.). To provide recipients with flexibility in assigning flexible gift objects to different entities, no gift object category may be directly associated with an individual entity.

In an embodiment, the flexible gift object assignment module 202 can prompt the user to provide identifying information associated with an intended recipient 112 of the flexible gift object. This identifying information may be used by the flexible gift object assignment module 202 to provide the user, through the user device 110, with one or more tailored recommendations corresponding to different gift object categories that may be associated with the flexible gift object and that may be appealing to the intended recipient 112. The identifying information that may be provided to the flexible gift object assignment module 202 may include the intended recipient's name, the intended recipient's physical address, the intended recipient's electronic mail address, any known interests or hobbies associated with the intended recipient 112, and the like. Additionally, the user may indicate, with the identifying information, the specific purpose for which the flexible gift object is being provided to the intended recipient 112. For example, the user may indicate that the flexible gift object is being given to the intended recipient 112 as a birthday gift for the intended recipient's child. As another example, the user may indicate that the flexible gift object is being given to the intended recipient 112 for the recipient's upcoming hiking trip to through the Pyrenees. This provided information may be used to construct a recipient profile that may be stored in a recipient information datastore 208 for use in generating tailored recommendations for gift object categories that may be provided to users looking to provide intended recipients with flexible gift objects, as well as for use in generating, for these intended recipients, tailored recommendations for particular entities that may be assigned to these flexible gift objects.

In an embodiment, the flexible gift object assignment module 202 can use any provided identifying information associated with the intended recipient to determine whether the flexible gift object assignment system 104 maintains, within the recipient information datastore 208, an existing recipient profile corresponding to the intended recipient. For example, the flexible gift object assignment module 202 may use the provided recipient information provided by the user to query the recipient information datastore 208 to determine whether an existing recipient profile corresponding to the intended recipient 112 is available. The existing recipient profile may have previously been generated in response to earlier requests to associate different flexible gift objects for the intended recipient 112 to different gift object categories. Further, the existing recipient profile may have previously been used to provide users and the intended recipient 112 with different gift object category recommendations and different assignment recommendations for these different flexible gift objects. In some instances, the existing recipient profile may include additional and/or alternative identifying information or characteristics associated with the intended recipient 112. For example, if the gifting distribution service 102 is associated with a financial institution through which the intended recipient 112 may maintain a line of credit, the gifting distribution service 102 may automatically update the recipient profile in real-time as this line of credit is used for different transactions. This information, as described in greater detail herein, may be used to identify any spending trends associated with the intended recipient 112 that may be used to generate tailored recommendations for gift object categories and corresponding entities that may be appealing to the intended recipient 112.

As illustrated in FIG. 2, the flexible gift object assignment module 202 may implement an assignment recommendation algorithm 204, which may be dynamically trained in real-time to provide users with recommendations corresponding to different gift object categories that may be associated with their flexible gift objects and that may be appealing to the intended recipients of these flexible gift objects. The assignment recommendation algorithm 204, in an embodiment, is a clustering algorithm that is dynamically trained in real-time to identify similar requests for associating flexible gift objects with particular gift object categories and similar recipient profiles (based on the provided or otherwise obtained identifying information associated with intended recipients) based on one or more vectors of similarity (e.g., recipient demographic information, recipient hobbies or interests, recipient spending trends, purpose for providing a flexible gift object, etc.). In some instances, the flexible gift assignment module 202, in training and using the assignment recommendation algorithm 204, may perform such clustering and obtain partial matches among other recipient profiles and/or requests to associated flexible gift objects to different gift object categories according to these one or more vectors of similarity. In an embodiment, the flexible gift object assignment module 202 can use a dataset of recipient profiles (real and/or hypothetical) and corresponding requests (real and/or hypothetical) to generate the various clusters associated with the assignment recommendation algorithm 204.

In an embodiment, in response to the request from the user device 110 to associate the flexible gift object to a gift object category, the flexible gift object assignment module 202 may use any available recipient information associated with the intended recipient 112 and any other known information corresponding to the flexible gift object (e.g., monetary value assigned to the flexible gift object, etc.) as input to the assignment recommendation algorithm 204 to generate a set of gift object category recommendations that may be provided to the user. As noted above, these gift object category recommendations may correspond to different gift object categories that may be appealing to the intended recipient 112, as determined through a processing of the available recipient information associated with the intended recipient 112. The flexible gift object assignment module 202 may provide these different gift object category recommendations to the user through their user device 110, which may allow the user to evaluate these recommendations and select a particular gift object category that is to be associated with the flexible gift object.

A selection of a particular gift object category for the flexible gift object can be used as feedback that may inform the flexible gift object assignment module 202 as to how the assignment recommendation algorithm 214 is to be updated in order to provide accurate or desired recommendations. For example, if the user selects a particular gift object category that was not recommended by the assignment recommendation algorithm 214 based on its evaluation of the provided recipient information and the characteristics of the flexible gift object, the flexible gift object assignment module 202 may adjust or otherwise modify the one or more vectors and corresponding clusters maintained by the assignment recommendation algorithm 214 such that the intended recipient 112 and other similarly-situated recipients are assigned similar classifications or clusters. This re-assignment may result in the assignment recommendation algorithm 214 generate more accurate or appealing gift object category recommendations for the user and other users. Alternatively, if the user selects a gift object category that was recommended by the assignment recommendation algorithm 214, the flexible gift object assignment module 202 may use this selection as a positive indicator of the assignment recommendation algorithm 214 generating accurate or appealing recommendations based on the current one or more vectors and corresponding clusters.

Once the user has provided their selection of a particular gift object category that is to be associated with the flexible gift object, the flexible gift object assignment module 202 may update the entry corresponding to the machine-readable label 118 implemented on the flexible gift object to associate this machine-readable label 118 with the selected gift object category. In some instances, the flexible gift object assignment module 202 may further associate the machine-readable label 118 with identifying information associated with the user that is to provide the flexible gift object to the intended recipient 112. For instance, the flexible gift object assignment module 202 may prompt the user to provide their name, physical address, electronic mail address, and the like that may be provided to the intended recipient 112 when activating the flexible gift object. Additionally, the flexible gift object assignment module 202 may prompt the user to provide a greeting or message that may be provided to the intended recipient 112 when the intended recipient 112 submits a request to activate the flexible gift object. The greeting or message may be provided as an audial, pictorial, and/or textual message that may be provided to the intended recipient 112.

In an embodiment, the flexible gift object assignment module 202 can provide the user with confirmation of the association of the flexible gift object with the selected gift object category and of the monetary value associated with the flexible gift object. The confirmation may further include a set of instructions that user may provide to the intended recipient 112 with regard to the activation process for the flexible gift object. This set of instructions, for instance, may include an instruction for the intended recipient 112 to scan the flexible gift object using their computing device or a point-of-sale terminal associated with a desired retailer for activating the flexible gift object and for assigning the flexible gift object to a particular retailer, merchant, or other entity. The confirmation, when received by the user through their user device 110, may serve as an indication to the user that they may now be able to provide the flexible gift object to the intended recipient 112 for their use.

When the intended recipient 112 receives a flexible gift object from a user, the recipient 112 may scan the machine-readable label 118 implemented on the flexible gift object to activate the flexible gift object for exclusive use with a particular retailer, merchant, or other entity. For instance, using a computing device, the recipient 112 may scan the machine-readable label 118 to extract the data encoded in the machine-readable label 118. As noted above, the machine-readable label 118 may encode a URI corresponding to a website or web portal associated with the gifting distribution service 102. Further, the machine-readable label 118 may encode executable instructions that, when executed by the computing device used by the recipient 112, may cause the computing device to execute a gifting application associated with the gifting distribution service 102. In an embodiment, the machine-readable label 118 can further encode a network address (e.g., IP address, MAC address, etc.) associated with the gifting distribution service 102 that may be used by a point-of-sale terminal (should the recipient attempt to activate the flexible gift object at a point-of-sale location) to transmit a request to the flexible gift object assignment module 202 to determine whether the flexible gift object can be assigned to the retailer or merchant associated with the point-of-sale terminal.

In response to obtaining the data extracted from the machine-readable label 118, the flexible gift object assignment module 202 may query the object datastore 106 to determine whether the machine-readable label 118 has been associated with a particular gift object category and to determine the monetary value associated with the flexible gift object. Further, if the user (e.g., sender of the flexible gift object) has provided a greeting or other message for the recipient 112, the flexible gift object assignment module 202 may retrieve this greeting or other message from the entry corresponding to the machine-readable label 118. In an embodiment, if the machine-readable label 118 was scanned through a point-of-sale terminal associated with a particular retailer or merchant (e.g., the data provided to the flexible gift object assignment module 202 includes identifying information associated with the point-of-sale terminal and/or the particular merchant or retailer, etc.), the flexible gift object assignment module 202 may determine whether the flexible gift object may be assigned to the retailer or merchant associated with this point-of-sale terminal. For example, if the machine-readable label 118 is currently assigned to another retailer such that use of the flexible gift object is limited to transactions associated with this other retailer, the flexible gift object assignment module 202 may determine that the flexible gift object may not be assigned to the retailer or merchant associated with the point-of-sale terminal. As another example, if the flexible gift object assignment module 202 determines that the flexible gift object has not been assigned to a particular retailer or merchant but is otherwise associated with a selected gift object category, the flexible gift object assignment module 202 may automatically, and in real-time, determine whether the retailer or merchant associated with the point-of-sale terminal corresponds to the gift object category associated with the flexible gift object. If the particular retailer or merchant does not correspond to the gift object category associated with the flexible gift object, the flexible gift object assignment module 202 may provide an indication that the flexible gift object cannot be assigned to the particular retailer or merchant. Alternatively, if the particular retailer or merchant does correspond to the gift object category associated with the flexible gift object, the flexible gift object assignment module 202 may assign this particular retailer or merchant to the flexible gift object, as described herein.

If the recipient 112 submits a request to activate the flexible gift object through their own computing device or any other computing device that is not associated with a particular retailer or merchant, the flexible gift object assignment module 202 may identify a set of retailers and merchants corresponding to the particular gift object category associated with the flexible gift object. The flexible gift object assignment module 202 may automatically provide the recipient 112 with a listing or other ordering of the set of retailers and merchants corresponding to this particular gift object category. For instance, if the recipient 112 accessed the gifting distribution service 102 through a gifting application implemented on the recipient's computing device, the flexible gift object assignment module 202 may dynamically, and in real-time, update a GUI associated with the gifting application to present the set of retailers and merchants corresponding to the gift object category associated with the flexible gift object. As another illustrative example, if the recipient 112 accessed the gifting distribution service 102 through a website of web portal implemented by the gifting distribution service 102, the flexible gift object assignment module 202 may redirect the recipient 112 to a landing page through which the recipient 112 may be presented with the set of retailers and merchants corresponding to the gift object category associated with the flexible gift object.

In some instances, the flexible gift object assignment module 202 may provide an ordering of the set of retailers and merchants corresponding to the gift object category according to different criteria. For instance, the flexible gift object assignment module 202 may order the set of retailers and merchants according to the proximity of points-of-sale locations associated with these different retailers and merchants to the recipient's location (e.g., a location specified by the recipient 112, a location determined based on GPS location data from the recipient's computing device, a physical address associated with the recipient 112, etc.). As another illustrative example, the gifting distribution service 102 may allow merchants and retailers to purchase sponsorships related to different gift object categories such that a sponsored merchant or retailer corresponding to a particular gift object category may be prominently presented to the recipient 112 as a selection option for assignment of the flexible gift object.

In an embodiment, the flexible gift object assignment module 202 can prompt the recipient 112 to provide identifying information associated with the recipient 112 that may be used to provide the recipient 112 with tailored recommendations corresponding to different retailers, merchants, and/or other entities that may be appealing to the recipient 112 for the given gift object category. For instance, the flexible gift object assignment module 202 may prompt the recipient 112 to provide their name, physical address, electronic mail address, and/or any other information that may be uniquely associated with the recipient 112. Using the provided identifying information, the flexible gift object assignment module 202 may query the recipient information datastore 208 to determine whether an existing recipient profile associated with the recipient 112 is available. As noted above, a recipient profile may indicate any spending trends associated with the recipient 112 that may be used to generate tailored recommendations for retailers, merchants, and/or other entities associated with a particular gift object category that may be appealing to the intended recipient 112. Further, the recipient profile may include historical information corresponding to previous assignments made by the recipient 112 for previously received flexible gift objects. In some instances, if the user (e.g., sender of the flexible gift object) previously provided recipient information corresponding to the recipient 112, this recipient information may be associated with the machine-readable label 118. Accordingly, the flexible gift object assignment module 202 may automatically obtain the identifying information associated with the recipient 112 from the object datastore 106 and use this identifying information to query the recipient information datastore 208 without requiring the recipient 112 to be prompted for this identifying information.

In an embodiment, the flexible gift object assignment module 202 may use the gift object category associated with the flexible gift object and the obtained recipient information (as provided by the recipient 112 and/or obtained from the recipient information datastore 208) as input to the assignment recommendation algorithm 204 to automatically, and in real-time, generate one or more assignment recommendations that may be provided to the recipient 112. These one or more assignment recommendations may correspond to one or more particular retailers, merchants, or other entities associated with the gift object category that may be appealing to the recipient 112 for assignment of the flexible gift object. In some instances, if the flexible gift object assignment module 202 determines that additional information associated with the recipient 112 may be beneficial in providing more accurate recommendations to the recipient 112, the flexible gift object assignment module 202 may prompt the recipient 112 for this additional information. This additional information may be used to supplement the existing recipient profile associated with the recipient 112 maintained in the recipient information datastore 208.

As the assignment recommendation algorithm 204 generates one or more assignment recommendations for the recipient 112, the flexible gift object assignment module 202 may provide these assignment recommendations to the recipient 112 as a set of assignment selection options corresponding to different retailers, merchants, and/or other entities to which the flexible gift object may be assigned. For instance, if the recipient 112 accesses the gifting distribution service 102 through a gifting application implemented on the recipient's computing device, the flexible gift object assignment module 202 may automatically, and in real-time, update an interface associated with the gifting application to present this set of assignment selection options. As another illustrative example, if the recipient 112 accesses the gifting distribution service 102 through a website or web portal associated with the gifting distribution service 102, the flexible gift object assignment module 202 may redirect the recipient 112 to a landing page associated with the gifting distribution service 102, through which the recipient 112 may be presented with this set of selection options.

As noted above, the set of assignment selection options may be automatically sorted based on a determined likelihood of the recipient 112 selecting a corresponding assignment selection option. For example, any assignment selection options corresponding to the assignment recommendations generated by the assignment recommendation algorithm 204 may be prioritized over other selection options corresponding to the gift object category associated with the flexible gift object 116 that may not have been recommended by the assignment recommendation algorithm 204. As another example, the set of assignment selection options may be ordered according to the known frequency at which the recipient 112 has purchased goods and/or services from the different retailers, merchants, and/or other entities associated with the set of assignment selection options, as determined through the recipient profile associated with the recipient 112. In some instances, the set of assignment selection options may be alternatively sorted according to one or more other criteria. For example, the set of assignment selection options may be ordered alphabetically. As another example, the set of assignment selection options may be ordered according to the proximity between the recipient's physical address and point-of-sale locations associated with the myriad retailers and/or merchants associated with the gift object category associated with the flexible gift object.

If the recipient 112 selects a particular retailer, merchant, or other entity that is to be assigned to the flexible gift object for exclusive use of the flexible gift object with this particular retailer, merchant, or other entity, the flexible gift object assignment module 202 may automatically update the entry corresponding to the machine-readable label 118 implemented on the flexible gift object to complete this assignment. The resulting entry, for instance, may include an indication of the gift object category associated with the machine-readable label 118, as well as an indication of the retailer, merchant, or other entity that has been assigned to the machine-readable label 118. Through this update, the flexible gift object may be designated for use exclusively with the assigned retailer, merchant, or other entity.

As noted above, once a flexible gift object has been assigned to a particular retailer, merchant, or other entity, the flexible gift object assignment system 104 may transmit data corresponding to the machine-readable label 118 to one or more systems associated with the assigned retailer, merchant, or other entity to allow the assigned retailer, merchant, or other entity to process transactions associated with the flexible gift object. This data may include the unique identifier corresponding to the machine-readable label 118 and the monetary amount associated with the flexible gift object 116. This may allow the assigned retailer, merchant, or other entity to process transactions involving the flexible gift object locally (such as through a point-of-sale terminal associated with the assigned retailer, merchant, or other entity) without requiring access to the gifting distribution service 102 for processing the transaction.

In some instances, the flexible gift object assignment system 104, along with the data corresponding to the machine-readable label 118, may transmit information corresponding to the recipient's selection of the assigned retailer, merchant, or other entity to these one or more systems associated with assigned retailer, merchant, or other entity. For instance, the flexible gift object assignment system 104 may transmit information corresponding to the recipient 112 (e.g., recipient name, recipient electronic mailing address, etc.) to these one or more systems to allow the assigned retailer, merchant, or other entity to perform additional actions when the recipient 112 utilizes the flexible gift object 116 at a point-of-sale terminal 114 associated with the particular retailer, merchant, or other entity. For example, the assigned retailer, merchant, or other entity may extend a customized message (e.g., a welcoming message, a message of appreciation, etc.) to the recipient 112 to indicate appreciation for the recipient 112 having selected to assign the flexible gift object 116 to the retailer, merchant, or other entity. In some instances, the assigned retailer, merchant, or other retailer may additionally, or alternatively, extend different benefits to the recipient 112 when the recipient 112 uses their flexible gift object 116 at the point-of-sale terminal 114 (e.g., discounts, additional loyalty rewards, free items or gifts, etc.).

In some instances, once the flexible gift object has been assigned to a particular retailer, merchant, or other entity, the flexible gift object assignment system 104 may further transmit a notification to the user device 110 to indicate the recipient's selection of the particular retailer, merchant, or other entity for assignment to the flexible gift object. For example, if the flexible gift object assignment system 104, in response to a recipient selection, assigns the flexible gift object to “Atzrbucks Coffee,” a particular coffee retailer associated with the “coffee” gift object category, the flexible gift object assignment system 104 may automatically generate and transmit the message “Thank you so much for the Atzrbucks Coffee!” to the user device 110. In some instances, the flexible gift object assignment system 104 may provide the recipient 112 with an opportunity to provide a tailored message to the user device 110 indicating their selection from the different retailers, merchants, and other entities associated with the gift object category assigned to the flexible gift object. For instance, the recipient 112, through an interface provided by the gifting distribution service 102, may be provided with one or more options to transmit a notification to the user device 110 corresponding to their selection. As an illustrative example, the flexible gift object assignment system 104 may allow the recipient 112 to generate a custom message that may be provided to the user device 110 (e.g., “Hi Kenneth, thanks for the Atzrbucks Coffee, mate!”). Alternatively, the flexible gift object assignment system 104 may provide different, pre-rendered messages that the recipient 112 may select for transmission to the user device 110 (e.g., “Thank you for the gift!,” “I love this gift!,” “I'll put this gift to good use!,” etc.).

In an embodiment, any selections made by the recipient 112 for assignment of the flexible gift object to a particular retailer, merchant, or other entity from the provided assignment recommendations and other assignment selection options may be used to dynamically, and in real-time, update the assignment recommendation algorithm 204. For instance, if the recipient 112 selects a particular retailer, merchant, or other entity that was not recommended by the assignment recommendation algorithm 204 through its assignment recommendations, the flexible gift object assignment module 202 may denote this selection as negative feedback that is indicative of a need to adjust or otherwise modify the one or more vectors and corresponding clusters maintained by the assignment recommendation algorithm 204 such that the recipient 112, and other similarly-situated recipients (e.g., recipients receiving flexible gift objects associated with similar gift object categories, recipients having similar purchase histories, recipients having similar interests or life events, etc.) are assigned similar classifications or clusters, thereby improving the accuracy of the assignment recommendations generated by the assignment recommendation algorithm 204. Alternatively, if the recipient 112 assigns the flexible gift object to a particular retailer, merchant, or other entity that was recommended by the assignment recommendation algorithm 204, the flexible gift object assignment module 202 may use this selection of the particular retailer, merchant, or other entity as positive feedback that may be used to further reinforce the assignment recommendation algorithm 204.

In response to the recipient's selection of a particular retailer, merchant, or other entity that is to be assigned to the flexible gift object, and once the flexible gift object assignment module 202 has updated the entry corresponding to the machine-readable label 118 associated with the flexible gift object to record this assignment, the flexible gift object assignment module 202 may provide the recipient 112 with a notification to indicate that the flexible gift object has been activated for exclusive use with the selected retailer, merchant, or other entity. This may allow the recipient 112 to use the flexible gift object for transactions associated with the selected retailer, merchant, or other entity. Further, if the recipient 112 attempts to use the flexible gift object for transactions associated with other retailers, merchants, or other entities that are not assigned to the flexible gift object, these transactions may be automatically declined.

In an embodiment, the flexible gift object assignment module 202 can continue to monitor transactions associated with the flexible gift object, as well as any spending trends associated with the recipient 112, in real-time to determine whether to provide the recipient 112 with one or more recommendations for re-assigning the flexible gift object to another retailer, merchant, or other entity. As noted above, the flexible gift object assignment module 202 may automatically, and in real-time, obtain location data associated with the recipient 112 (such as through a gifting application or other application implemented on the recipient's computing device), that may be used to determine whether to provide the recipient 112 with a recommendation to re-assign the flexible gift object to another retailer, merchant, or other entity. Returning to an earlier illustrative example, if the flexible gift object assignment module 202, through evaluation of the location data associated with the recipient 112, determines that the recipient 112 has been at a location for a threshold period of time where the assigned entity does not maintain a point-of-sale location or otherwise does not maintain a presence at the location, the flexible gift object assignment module 202 may use the assignment recommendation algorithm 204 described herein to identify other retailers, merchants, or other entities that may correspond to this location and that may be recommended to the recipient 112 for re-assignment of the flexible gift object. The recipient 112 may evaluate these new assignment recommendations and determine whether to re-assign the flexible gift object to another retailer, merchant, or other entity. This determination by the recipient 112 may be used to dynamically update the assignment recommendation algorithm 204, similar to the process described above for updating the assignment recommendation algorithm 204 according to recipient selection of an assignment option for the flexible gift object.

As noted above, the flexible gift object assignment system 104 may maintain, in a recipient information datastore 208, a recipient profile corresponding to each recipient of a flexible gift object. A recipient profile corresponding to the recipient 112 may include data corresponding to spending trends associated with recipient 112, as determined through an evaluation of transactions associated with the recipient 112 and provided through one or more financial institutions, credit reporting agencies, and other entities associated with the gifting distribution service 102. In an embodiment, the flexible gift object assignment module 202 may, in real-time, monitor these transactions and corresponding spending trends associated with the recipient 112 to determine whether to provide the recipient 112 with one or more recommendations for re-assigning the flexible gift object to another retailer, merchant, or other entity. Returning to an earlier illustrative example, if the flexible gift object assignment module 202 determines that the flexible gift object has not been used for transactions associated with the assigned retailer, merchant, or other entity over a threshold period of time, the flexible gift object assignment module 202 may use the assignment recommendation algorithm 204 to generate one or more new assignment recommendations corresponding to other retailers, merchants, or entities that may be assigned to the flexible gift object. Based on the recipient's response to these new assignment recommendations (e.g., request to re-assign the flexible gift object to another retailer, merchant, or other entity, rejection of the new assignment recommendations, etc.), the flexible gift object assignment module 202 may dynamically update the assignment recommendation algorithm 204.

In some instances, the recipient 112 may desire to re-assign the flexible gift object to another retailer, merchant, or other retailer absent any recommendations from the flexible gift object assignment module 202. For instance, the recipient 112, using their computing device, may scan the machine-readable label 118 to access the flexible gift object assignment module 202 and request re-assignment of the associated flexible gift object to another retailer, merchant, or other retailer. In response to obtaining the data encoded on the machine-readable label 118, the flexible gift object assignment module 202 may query the object datastore 106 to identify the current assignment associated with the flexible gift object. The flexible gift object assignment module 202 may provide information corresponding to the present assignment to the recipient 112. Additionally, the flexible gift object assignment module 202 may provide the recipient 112 with one or more options for re-assigning the flexible gift object to another retailer, merchant, or entity associated with the gift object category associated with the flexible gift object. These one or more assignment options may be generated using the assignment recommendation algorithm 204, as described above. These one or more assignment options, for instance, may be provided based on newly generated assignment recommendations corresponding to other retailers, merchants, or entities that may be appealing to the recipient 112 and that may be assigned to the flexible gift object. If the recipient 112 selects another retailer, merchant, or entity for assignment to the flexible gift object, the flexible gift object assignment module 202 may update the entry corresponding to the machine-readable label 118 implemented on the flexible gift object to reflect this change in assignment.

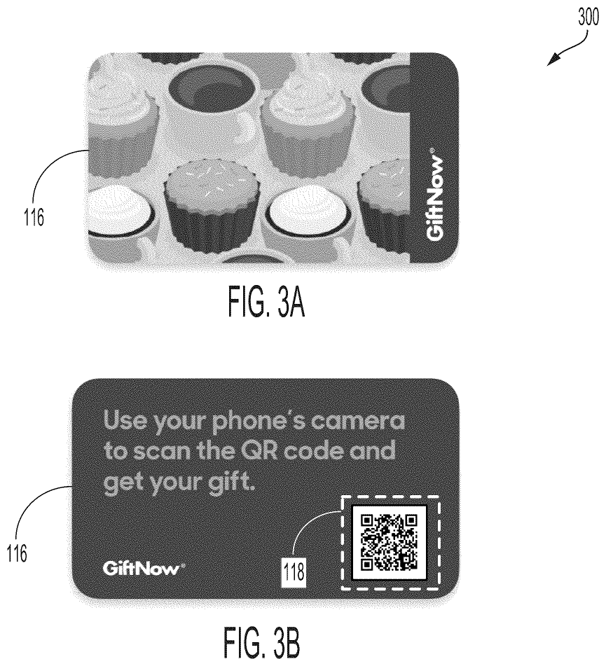

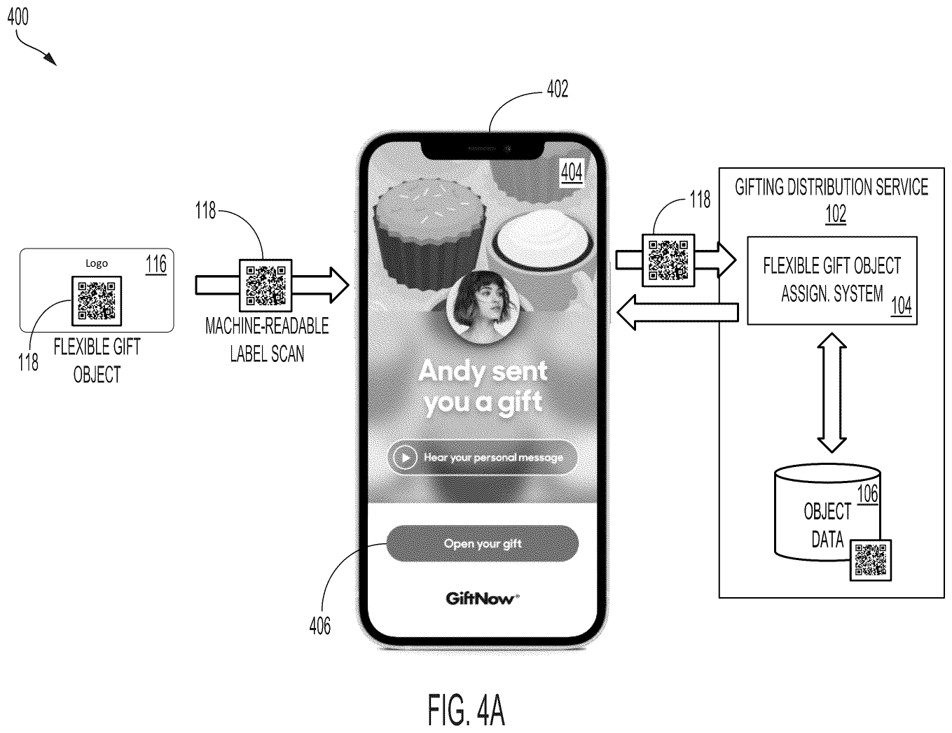

FIGS. 3A-3B show an illustrative example of an environment 300 in which a flexible gift object 116 is provided in accordance with at least one embodiment. In the environment 300, and as illustrated in FIGS. 3A-3B, the flexible gift object 116 may be implemented as a physical card that includes one or more elements that may be used to indicate one or more characteristics of the flexible gift object 116 and that may be used to both associate the flexible gift object 116 with a particular gift object category and to assign the flexible gift object 116 to a particular retailer, merchant, or other entity associated with the particular gift object category. For example, as illustrated in FIG. 3A, the flexible gift object 116 may include an image that is representative of a gift object category that is assigned to the flexible gift object 116 by default. For instance, the image of cupcakes and cups of coffee (as illustrated in FIG. 3A) may serve an indication that the flexible gift object 116 is associated with a “coffee” gift object category, whereby the flexible gift object 116, by default, is to be limited for use in transactions involving coffee-related purchases. In some instances, the image presented on the flexible gift object 116 may be generic, in that the image may not be representative of a particular gift object category that is, by default, associated with the flexible gift object 116. This may provide the gifting distribution service with flexibility in customizing the appearance of flexible gift objects for different purposes.

As illustrated in FIG. 3B, the flexible gift object 116, on an obverse side of the flexible gift object 116, may include a unique machine-readable label 118 that may initially be unassigned to a particular retailer, merchant, or other entity. For instance, when a sender of the flexible gift object 116 first obtains the flexible gift object 116 (such as through the gifting distribution service or other entity that makes unassigned flexible gift objects available for purchase), the machine-readable label 118 may not be associated with a particular retailer, merchant, or other entity. However, if the flexible gift object 116 is, by default, associated with a particular gift object category, the machine-readable label 118 may be associated with this particular gift object category. Alternatively, if the flexible gift object 116 is not initially associated with a particular gift object category, the machine-readable label 118 may also be unassociated with any gift object category.

As noted above, the machine-readable label 118 may encode data that may be used to uniquely identify the machine-readable label 118 and the flexible gift object 116 that implements the machine-readable label 118. This data may include a unique identifier associated with the machine-readable label 118 and the flexible gift object 116. Further, this unique identifier may be associated with an entry in an object datastore maintained by the gifting distribution service, through which the gifting distribution service may associate the machine-readable label 118 with a particular gift object category, a particular retailer, merchant, or other entity, and with a monetary value, as described above. In addition to encoding data that may uniquely identify the machine-readable label 118 and the flexible gift object 116, the machine-readable label 118 may further encode a URI corresponding to a website or web portal through which users may associate the flexible gift object 116 with a particular gift category, assign a monetary value to the flexible gift object 116, provide recipient information that may be used to dynamically provide the user and the recipient with various tailored recommendations for the flexible gift object 116, and the like. Additionally, and or alternatively, the machine-readable label 118 may encode executable instructions that, when processed and executed by a computing device upon scanning of the machine-readable label 118, may cause the computing device to execute a gifting application implemented on the computing device. The gifting application may be associated with the gifting distribution service and may provide the computing device with access to the gifting distribution service through one or more APIs, as described above.

It should be noted that while a QR code is used to represent the machine-readable label 118 in FIG. 3B, flexible gift objects may be implemented with different types of machine-readable labels. For example, the machine-readable label 118 may be implemented using any form of one- or two-dimensional code that can be used to encode information and/or executable instructions (e.g., high capacity color barcodes, NexCode, ShotCode, Qode, Data Matrix, CrontoSign, Aztec Code, barcodes, etc.).

A sender of the flexible gift object 116 may scan the machine-readable label 118 using their computing device to access the gifting distribution service, as described above, to associate the flexible gift object 116 with a particular gift object category. If the flexible gift object 116 is already associated with a particular gift object category by default, the sender of the flexible gift object 116 may be prompted to assign a monetary value to the flexible gift object 116 (if not already assigned upon purchase of the flexible gift object 116 or otherwise assigned by default). Additionally, through the gifting distribution service, the sender of the flexible gift object 116 may be prompted to provide any information associated with the intended recipient, which may be used to dynamically generate one or more assignment recommendations that may be presented to the recipient when they scan the machine-readable label 118, as described above. In some instances, through the gifting distribution service, the sender of the flexible gift object 116 may further provide a custom greeting or message that may be presented to the recipient when they scan the machine-readable label 118. The aforementioned information provided by the sender of the flexible gift object 116 may be associated with the entry corresponding to the machine-readable label 118 maintained by the gifting distribution service. This may allow the gifting distribution service to automatically retrieve this information from the entry when the recipient scans the machine-readable label 118 to request assignment of the flexible gift object 116 to a particular retailer, merchant, or other entity.

In some instances, the flexible gift object 116 may include one or more instructions for scanning the machine-readable label 118 in order to assign the flexible gift object 116 to a particular retailer, merchant, or other entity. For example, as illustrated in FIG. 3B, the flexible gift object 116 may include the instruction “Use your phone's camera to scan the QR code and get your gift.” This instruction may indicate, to a recipient of the flexible gift object 116, that they are to use their computing device (e.g., a mobile phone, etc.) to scan the machine-readable label 118 implemented on the flexible gift object 116 in order to activate the flexible gift object 116. As noted above, the machine-readable label 118 may encode a URI corresponding to a website or web portal provided by the gifting distribution service, through which the recipient may assign the flexible gift object 116 to a particular retailer, merchant, or other entity. Additionally, the machine-readable label 118 may further encode executable instructions that, when executed by the recipient's computing device, may cause the computing device to execute a gifting application associated with the gifting distribution service. Through this gifting application, the recipient may be presented with different assignment selection options for assigning the flexible gift object 116 to a particular retailer, merchant, or other entity, as described above.

Once the recipient of the flexible gift object 116 has assigned the flexible gift object 116 to a particular retailer, merchant, or other entity through the gifting distribution service, the flexible gift object 116 may be deemed activated for exclusive use with the particular retailer, merchant, or other entity. As noted above, if the recipient attempts to use the flexible gift object 116 with a different retailer, merchant, or other entity other than the one assigned to the flexible gift object 116, any corresponding transactions associated with this different retailer, merchant, or other entity may be automatically rejected or otherwise not recognized by the different retailer, merchant, or other entity. In some instances, the recipient may scan the machine-readable label 118 at any time after assignment to a different retailer, merchant, or other entity to access the gifting distribution service to request re-assignment of the flexible gift object 116 to a different retailer, merchant, or other entity, as described above.

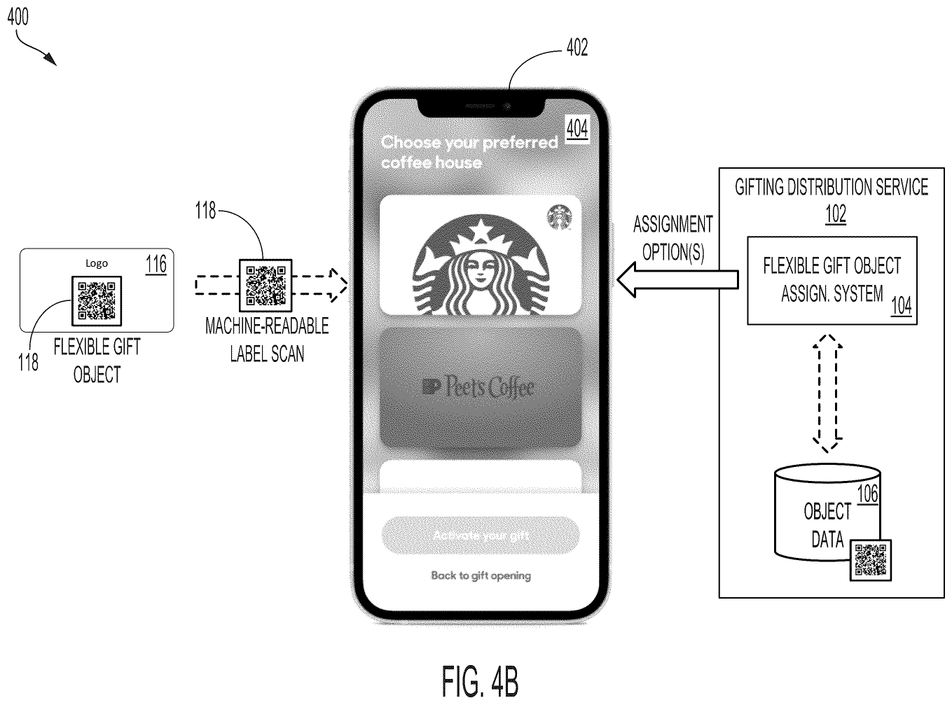

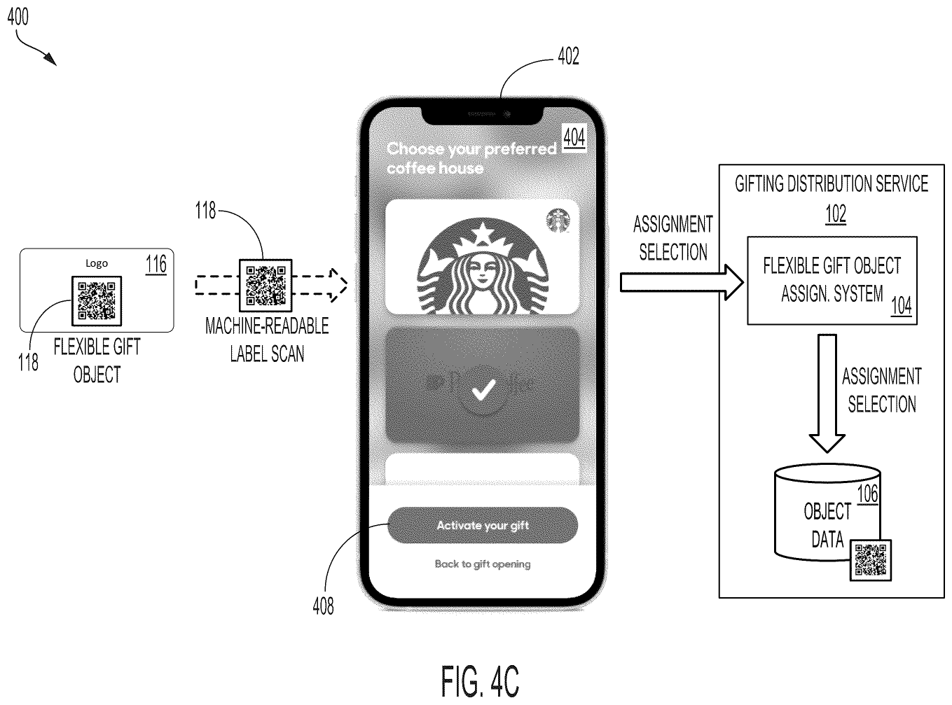

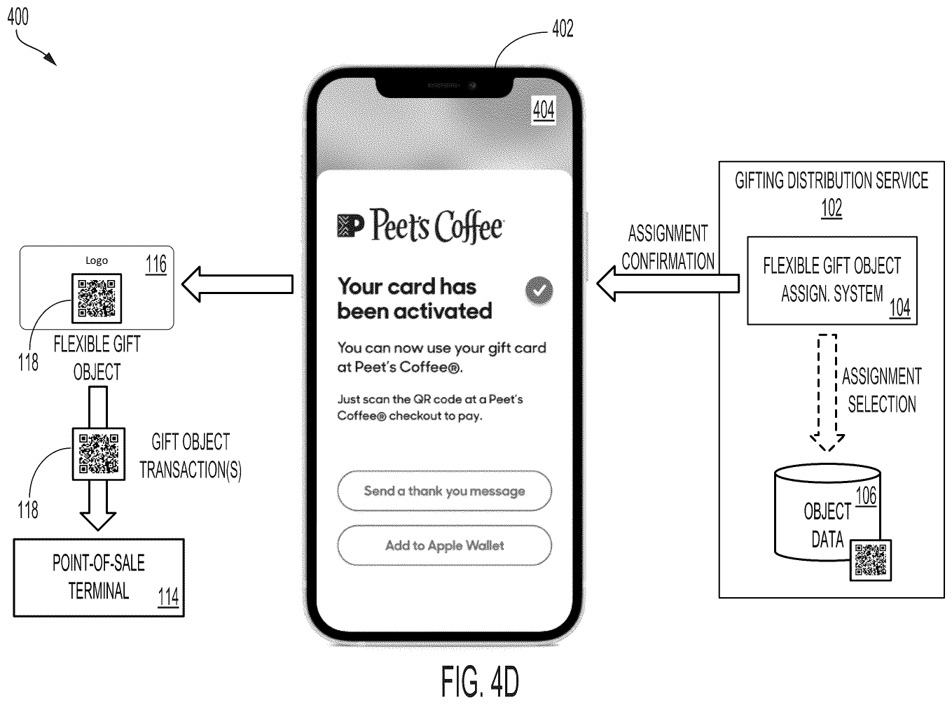

FIGS. 4A-4D show an illustrative example of an environment 400 in which a recipient of a flexible gift object 116, through a computing device 402, scans the flexible gift object 116 in order to activate and assign the flexible gift object 116 to a particular entity in accordance with at least one embodiment. In the environment, and as illustrated in FIG. 4A, a recipient of a flexible gift object 116 may use their computing device 402 to scan a machine-readable label 118 implemented on the flexible gift object 116 in order to request activation of the flexible gift object 116. As noted above, and illustrated in FIG. 3B, the flexible gift object 116 may include a set of instructions that may instruct the recipient to scan the machine-readable label 118 using their computing device 402 in order to redeem their gift (e.g., activate the flexible gift object 116 for their use).

As noted above, the machine-readable label 118 may encode a URI corresponding to a website or web portal provided by the gifting distribution service 102, through which the recipient may assign the flexible gift object 116 to a particular retailer, merchant, or other entity. Additionally, the machine-readable label 118 may further encode executable instructions that, when executed by the recipient's computing device 402, may cause the computing device 402 to execute a gifting application associated with the gifting distribution service 102. Through this gifting application, the recipient may be presented with different assignment selection options for assigning the flexible gift object 116 to a particular retailer, merchant, or other entity, as described in greater detail herein.

As illustrated in FIG. 4A, when the recipient uses their computing device 402 to scan the machine-readable label 118, the gifting distribution service 102, through the flexible gift object assignment system 104, may update the computing device 402 to provide a GUI 404 through which the recipient may receive their gift. The GUI 404 may be provided through a website or web portal associated with the gifting distribution service 102. For instance, if the machine-readable label 118 encodes the URI corresponding to this website or web portal, and the computing device 402 docs not implement a gifting application associated with the gifting distribution service 102, the computing device 402 may automatically execute a browser application implemented on the computing device 402. The browser application may automatically use the URI encoded in the machine-readable label 118 to access the website or web portal associated with the gifting distribution service 102. In some instances, the GUI 404 may be provided through the gifting application provided by the gifting distribution service 102 and that may be implemented on the computing device 402. For instance, if the computing device 402 implements this gifting application, the computing device 402 may automatically execute the gifting application in response to the executable instructions encoded on the machine-readable label 118 and obtained upon scanning of the machine-readable label 118. The gifting application may access the flexible gift object assignment system 104 through one or more APIs implemented by the gifting distribution service 102. Accordingly, the flexible gift object assignment system 104, through these APIs, may provide the GUI 404 to the gifting application.

In an embodiment, when the recipient scans the machine-readable label 118 using their computing device 402, the computing device 402 may provide (such as through the gifting application or the website/web portal provided by the gifting distribution service 102) the data encoded on the machine-readable label 118 to the flexible gift object assignment system 104. As noted above, the encoded data may include a unique identifier associated with the machine-readable label 118 and the flexible gift object 116. In response to receiving the data encoded in the machine-readable label 118 associated with the flexible gift object 116, the flexible gift object assignment system 104 uses the provided data to query an object datastore 106 to identify an entry corresponding to the machine-readable label 118. An entry corresponding to the machine-readable label 118 may indicate the gift object category that is associated with the flexible gift object 116 as defined by a sender of the flexible gift object 116 or by default by the gifting distribution service 102. Additionally, this entry corresponding to the machine-readable label 118 may indicate the monetary value associated with the flexible gift object 116 and that may be available to the recipient. In some instances, the entry may further include identifying information associated with the sender of the flexible gift object 116. For example, the sender of the flexible gift object 116 may provide their name, physical address, electronic mail address, and the like. Further, in some instances, the entry may include a custom greeting or message provided by the sender of the flexible gift object 116 that may be presented to the recipient when the recipient accesses the gifting distribution service 102 to activate their flexible gift object 116.

Based on the information included in the entry corresponding to the machine-readable label 118, the flexible gift object assignment system 104 may dynamically, and in real-time, update the GUI 404 to provide the recipient with information regarding their flexible gift object 116. For example, as illustrated in FIG. 4A, the flexible gift object assignment system 104 may present, through the GUI 404, information corresponding to the sender of the flexible gift object 116. For instance, as illustrated in FIG. 4A, the flexible gift object assignment system 104 can update the GUI 404 to provide an indication of who has provided the flexible gift object 116 to the recipient (e.g., “Andy sent you a gift”). Further, through the GUI 404, the flexible gift object assignment system 104 may provide the recipient with an option to receive any custom greetings or messages provided by the sender of the flexible gift object 116. For example, as illustrated in FIG. 4A, the flexible gift object assignment system 104 may indicate that the sender of the flexible gift object 116 (e.g., “Andy”) has provided an audial “personal message” for the recipient. Accordingly, through the GUI 404, the flexible gift object assignment system 104 may provide one or more interface elements that may be used by the recipient to access any custom greetings or messages provided by the sender of the flexible gift object 116.

Through the GUI 404, the flexible gift object assignment system 104 may further provide the recipient with an option to being the activation process for the flexible gift object 116. For example, as illustrated in FIG. 4A, the flexible gift object assignment system 104 may provide the recipient with an activation button 406 or other interface element that, when selected, may cause the computing device 402 to transmit a request to the flexible gift object assignment system 104 to initiate an assignment process for assigning a particular retailer, merchant, or other entity to the flexible gift object 116 according to the gift object category associated with the flexible gift object 116. Accordingly, when the recipient selects the activation button 406, the flexible gift object assignment system 104 may begin to identify a set of possible assignment options corresponding to the gift object category associated with the flexible gift object 116.

As illustrated in FIG. 4B, the recipient has selected the activation button 406 and the flexible gift object assignment system 104 has updated the GUI 404 to provide the recipient with a set of assignment options for the flexible gift object 116. As noted above, the flexible gift object assignment system 104 may implement an assignment recommendation algorithm that is dynamically trained, in real-time, to provide assignment recommendations corresponding to different retailers, merchants, and/or other entities associated with a particular gift object category and that may be appealing to the recipient. In an embodiment, the flexible gift object assignment system 104 uses the gift object category associated with the flexible gift object 116 and any available recipient information (as provided by the recipient 112 through their computing device 402 and/or obtained from the recipient information datastore, as described above) as input to the assignment recommendation algorithm to automatically, and in real-time, generate the one or more assignment recommendations that may be provided to the recipient. In some instances, if the flexible gift object assignment system 104 determines that additional information associated with the recipient may be beneficial in providing more accurate recommendations to the recipient, the flexible gift object assignment system 104 may prompt the recipient, through the GUI 404, for this additional information. This additional information may be used to supplement the existing recipient profile associated with the recipient, as described above.

Any recommendations generated by the assignment recommendation algorithm implemented by the flexible gift object assignment system 104 may be presented to the recipient through the GUI 404 as a set of assignment selection options corresponding to different retailers, merchants, and/or other entities to which the flexible gift object 116 may be assigned. For example, as illustrated in FIG. 4B, the flexible gift object assignment system 104, through the GUI 404, may provide the recipient with various graphical representations of different retailers, merchants, and/or other entities to which the flexible gift object 116 may be assigned. These various graphical representations may further represent the different assignment options available to the recipient, thus allowing the recipient to select a particular graphical representation of a retailer, merchant, or other entity to indicate their selection of a particular assignment option. As illustrated in FIG. 4B, a graphical representation of a particular retailer, merchant, or other entity may include identifying information corresponding to this particular retailer, merchant, or other entity. For instance, a particular graphical representation may include the name of the entity, any trademarks or logos associated with the entity, information corresponding to any of the goods and/or services provided by the entity, information corresponding to different point-of-sale locations associated with the entity, and the like.

In some instances, the graphical representation of the different assignment selection options presented to the recipient through the GUI 404 may be automatically sorted based on a determined likelihood of the recipient selecting a corresponding assignment selection option. As noted above, any assignment selection options corresponding to the assignment recommendations generated by the assignment recommendation algorithm may be prioritized over other selection options corresponding to the gift object category associated with the flexible gift object 116 that may not have been recommended by the assignment recommendation algorithm. Alternatively, in some instances, the set of assignment selection options presented through the GUI 404 may be ordered by the flexible gift object assignment system 104 according to the known frequency at which the recipient 112 has purchased goods and/or services from the different retailers, merchants, and/or other entities associated with the set of assignment selection options. The graphical representation of the different assignment selection options presented to the recipient through the GUI 404 may be sorted, in some instances, alphabetically without regard to any known recipient trends or to the generated assignment selection option recommendations. As another example, the graphical representation of the different assignment selection options may be sorted according to the proximity between the recipient's physical address and point-of-sale locations associated with the corresponding retailers, merchants, and other entities associated with these assignment selection options.

As illustrated in FIG. 4C, the recipient, through the GUI 404, has selected a particular assignment selection option corresponding to a particular retailer, merchant, or other entity. For example, through the GUI 404, the recipient may select a graphical representation of a particular retailer, merchant, or other entity to indicate their request to assign the flexible gift object 116 to this particular retailer, merchant, or other entity. When a recipient selects a particular graphical representation of a particular retailer, merchant, or other entity, the flexible gift object assignment system 104 may, in real-time, update the GUI 404 to provide the recipient with verification regarding their selection. For example, as illustrated in FIG. 4C, when the recipient selects the graphical representation corresponding to “Peet's Coffee,” the flexible gift object assignment system 104 may dynamically update the GUI 404 to highlight this graphical representation corresponding to “Peet's Coffee®” and supplement this graphical representation with a checkmark that may be superimposed over this graphical representation. However, it should be noted that the flexible gift object assignment system 104 may use any mechanism for providing the recipient with verification of their selection of a particular assignment selection option through the GUI 404 (e.g., text verification, boxing of the option, removing any unselected options, increasing the size of the graphical representation associated with selected option, decreasing the size of the graphical representations associated with any unselected options, etc.).

In an embodiment, when the recipient selects a particular assignment selection option through the GUI 404, the flexible gift object assignment system 104 can dynamically update the GUI 404 to provide the recipient with one or more options to confirm their selection and finalize assignment of the flexible gift object 116 to the selected retailer, merchant, or other entity. For instance, as illustrated in FIG. 4C, the flexible gift object assignment system 104 may update the GUI 404 to allow the recipient to select an activation button 408 through which the recipient may confirm their selection of a particular assignment option and to submit a request to activate the flexible gift object 116 with the retailer, merchant, or other entity associated with the particular assignment option. Once the recipient selects the activation button 408, the computing device 402 may transmit the recipient's selection of the particular assignment selection option and a corresponding request to assign the flexible gift object 116 to the retailer, merchant, or other entity associated with the particular assignment selection option.

In response to the assignment request from the recipient, the flexible gift object assignment system 104 may record the particular assignment selection option selected by the recipient in the entry corresponding to the machine-readable label 118 implemented on the flexible gift object 116. The updated entry in the object datastore 106 may include an indication of the gift object category associated with the machine-readable label 118, as well as an indication of the retailer, merchant, or other entity that has been assigned to the machine-readable label 118. Through this update, the flexible gift object may be designated for use exclusively with the assigned retailer, merchant, or other entity.

Once the flexible gift object assignment system 104 has updated the entry corresponding to the machine-readable label 118 implemented on the flexible gift object 116 to assign the flexible gift object 116 to the selected retailer, merchant, or other entity, the flexible gift object assignment system 104 may update the GUI 404 to indicate that the flexible gift object 116 has been activated for exclusive use with the selected retailer, merchant, or other entity. For example, as illustrated in FIG. 4D, the flexible gift object assignment system 104 may update the GUI 404 to indicate that the recipient may now use their flexible gift object 116 at any Peet's Coffee® point-of-sale location. Further, the flexible gift object assignment system 104 may provide, through the GUI 404, instructions for how to use the flexible gift object 116 at point-of-sale locations associated with the selected retailer, merchant, or other entity. For example, as illustrated in FIG. 4D, the flexible gift object assignment system 104 may instruct the recipient to scan the machine-readable label 118 at any point-of-sale terminal 114 associated with the assigned recipient, merchant, or other entity in order to be able to use the flexible gift object 116 for transactions associated with the assigned recipient, merchant, or other entity.

As noted above, once a flexible gift object 116 has been assigned to a particular retailer, merchant, or other entity, the flexible gift object assignment system 104 may transmit data corresponding to the machine-readable label 118 implemented on the flexible gift object 116 to one or more systems associated with the assigned retailer, merchant, or other entity. This may allow the assigned retailer, merchant, or other entity to process transactions associated with the flexible gift object 116 when the recipient scans the machine-readable label 118 through a point-of-sale terminal 114 associated with the assigned retailer, merchant, or other entity. This data may include the unique identifier corresponding to the machine-readable label 118 and the monetary amount associated with the flexible gift object 116. This may allow the assigned retailer, merchant, or other entity to process transactions involving the flexible gift object locally (such as through a point-of-sale terminal 114 associated with the assigned retailer, merchant, or other entity) without requiring access to the gifting distribution service 102 for processing of the transaction.

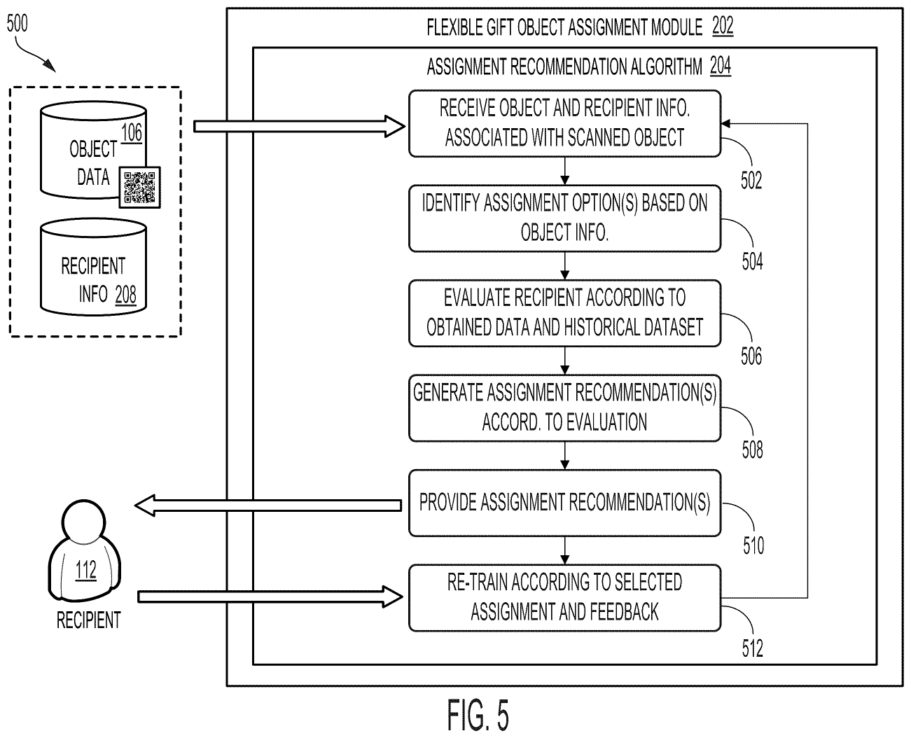

FIG. 5 shows an illustrative example of an environment 500 in which an assignment recommendation algorithm 204 is dynamically trained to provide recipients of flexible gift objects with assignment recommendations when requesting activation of flexible gift objects in accordance with at least one embodiment. As noted above, a recipient 112 of a flexible gift object may scan the machine-readable label implemented on the flexible gift object to access the flexible gift object assignment system to request assignment of the flexible gift object to a particular retailer, merchant, or other entity. Through this request, the recipient's computing device may transmit data extracted from the machine-readable label that may be used to uniquely identify the machine-readable label and identify one or more characteristics of the flexible gift object that implements the machine-readable label. For instance, the data extracted from the machine-readable label may include a unique identifier corresponding to the machine-readable label and, hence, the flexible gift object.

The flexible gift object assignment module 202, in an embodiment, uses the unique identifier corresponding to the machine-readable label and provided by the recipient 112, to identify an entry corresponding to the machine-readable label from an object datastore 106. As noted above, the entry corresponding to the machine-readable label may indicate the gift object category associated with the flexible gift object, as well as the monetary value assigned to the flexible gift object, information corresponding to the sender of the flexible gift object, a custom greeting or message provided by the sender of the flexible gift object, and identifying information associated with the intended recipient (e.g., recipient 112) of the flexible gift object (e.g., recipient name, recipient electronic mail address, etc.). In some instances, and as noted above, the flexible gift object may be assigned a value corresponding to a number of units of a cryptocurrency that, according to an exchange rate keyed to fiat currencies, may have a fluctuating monetary value. Accordingly, the flexible gift object may further have a flexible monetary value associated with it. If the entry includes identifying information associated with the intended recipient, the flexible gift object assignment module 202 may query a recipient information datastore 208 to obtain additional information associated with the recipient 112 that may be used to provide tailored recommendations to the recipient 112 corresponding to different retailers, merchants, and/or other entities that may be appealing to the recipient 112 for assignment to the flexible gift object, as described herein. Alternatively, the flexible gift object assignment module 202 may prompt the recipient to provide additional information about the recipient 112 that may be used to provide these tailored recommendations.

In the environment 500, the flexible gift object assignment module 202 may provide the obtained information corresponding to the machine-readable label implemented on the flexible gift object, as well as any available information corresponding to the recipient 112, to the assignment recommendation algorithm 204 to generate these tailored recommendations corresponding to different retailers, merchants, and/or other entities that may be appealing to the recipient 112 for assignment to the flexible gift object. Thus, at step 502, the assignment recommendation algorithm 204 may receive information corresponding to the flexible gift object and to the intended recipient of the flexible gift object.

At step 504, the assignment recommendation algorithm 204 may identify a set of assignment options based on the information associated with the flexible gift object. As noted above, the flexible gift object may be associated with a particular gift object category. For example, a sender of the flexible gift object may scan an unassigned flexible gift object to assign a monetary value to the flexible gift object and to indicate the gift object category for the flexible gift object. Alternatively, the flexible gift object may, by default (e.g., without user intervention), be assigned with a particular gift object category. A gift object category may be associated with different retailers, merchants, and other entities that may provide goods and/or services related to the gift object category. Returning to an earlier illustrative example, a gift object category corresponding to “coffee” may be associated with one or more coffee vendors that may provide, online and/or through one or more point-of-sale locations, different coffee-related goods and/or services. As another illustrative example, a gift object category corresponding to “restaurants” may be associated with one or more different participating restaurants through which the flexible gift object may be used. Thus, based on the identified gift object category associated with the flexible gift object, the assignment recommendation algorithm 204 can identify the different retailers, merchants, and other entities that are associated with this particular gift object category.

At step 506, the assignment recommendation algorithm 204 may evaluate the obtained recipient information corresponding to the recipient 112 according to the identifying information associated with the recipient 112 (as provided by the sender of the flexible gift object or the recipient 112), any available historical information associated with the recipient 112 (e.g., past purchase histories, past gift redemption histories, etc.), and the gift object category associated with the flexible gift object. The assignment recommendation algorithm 204 may use this provided information to identify similar recipients and flexible gift objects based on one or more vectors of similarity (e.g., demographic information, recipient interests, event or purpose for gifting of the flexible gift objects, historical information associated with the recipients, monetary value associated with the flexible gift objects, etc.). The assignment recommendation algorithm 204 may obtain partial matches among other recipient profiles and/or other flexible gift objects according to these one or more vectors of similarity. Through these partial matches, the assignment recommendation algorithm 204 may identify a particular cluster that best matches the characteristics of the recipient 112 and of the corresponding flexible gift object provided to the recipient 112. From this cluster, the assignment recommendation algorithm 204, at step 508, may identify a set of retailers, merchants, and/or other entities associated with the gift object category that may be recommended to the recipient 112 as possible assignment selection options for the flexible gift object.

At step 510, the assignment recommendation algorithm 204 may provide the generated assignment recommendations to the recipient 112. As noted above, as the assignment recommendation algorithm 204 generates one or more assignment recommendations for the recipient 112, the flexible gift object assignment module 202 may provide these assignment recommendations to the recipient 112 as a set of assignment selection options corresponding to different retailers, merchants, and/or other entities to which the flexible gift object may be assigned. For instance, if the recipient 112 accesses the gifting distribution service through a gifting application implemented on the recipient's computing device, the flexible gift object assignment module 202 may automatically, and in real-time, update an interface associated with the gifting application to present this set of assignment selection options. As another illustrative example, if the recipient 112 accesses the gifting distribution service through a website or web portal associated with the gifting distribution service, the flexible gift object assignment module 202 may redirect the recipient 112 to a landing page associated with the gifting distribution service, through which the recipient 112 may be presented with this set of selection options.

The assignment recommendation algorithm 204 may provide, for the generated assignment recommendations, a sorting or other listing of the corresponding assignment selection options according to a determined likelihood of the recipient 112 selecting a corresponding assignment selection option. For instance, the set of assignment selection options recommended by the assignment recommendation algorithm 204 may be prioritized over any other available assignment selection options that are not recommended by the assignment recommendation algorithm 204. In some instances, the flexible gift object assignment module 202 may evaluate the assignment recommendations generated by the assignment recommendation algorithm 204 and rank these assignment recommendations according to a known frequency at which the recipient 112 has engaged the corresponding retailers, merchants, and/or other entities associated with these assignment recommendations. As another illustrative example, the flexible gift object assignment module 202 may sort the set of assignment selection options according to the recipient's proximity to point-of-sale locations associated with the myriad retailers and/or merchants associated with the generated assignment recommendations. In some instances, the set of assignment selection options may be sorted based on objective criteria not associated with the recipient 112. For example, the set of assignment selection options may be sorted alphabetically or based on a popularity of the set of assignment selection options amongst a set of recipients associated with the gifting distribution service over time.

At step 512, the assignment recommendation algorithm 204 may be re-trained or otherwise updated according to the recipient's selection of a particular assignment selection option for their flexible gift object. For instance, if the recipient 112 selects a particular retailer, merchant, or other entity that was not recommended by the assignment recommendation algorithm 204, the flexible gift object assignment module 202 may denote this selection as negative feedback that is indicative of a need to adjust or otherwise modify the one or more vectors and corresponding clusters maintained by the assignment recommendation algorithm 204 such that the recipient 112, and other similarly-situated recipients are assigned similar classifications or clusters, thereby improving the accuracy of the assignment recommendations generated by the assignment recommendation algorithm 204. Alternatively, if the recipient 112 assigns the flexible gift object to a particular retailer, merchant, or other entity that was recommended by the assignment recommendation algorithm 204, the flexible gift object assignment module 202 may use this selection of the particular retailer, merchant, or other entity as positive feedback that may be used to further reinforce the assignment recommendation algorithm 204.

It should be noted that the operations performed by the assignment recommendation algorithm 204, as illustrated in FIG. 5, may be performed simultaneously for any number of recipients of flexible gift objects, in real-time, and as these recipients submit requests to active their flexible gift objects for use with selected retailers, merchants, and/or other entities. For instance, the assignment recommendation algorithm 204 may generate and provide different assignment recommendations to different recipients in real-time as their requests are received by the flexible gift object assignment module 202. Further, as different recipients make different assignment option selections, the assignment recommendation algorithm 204 may be continuously re-trained or otherwise updated in real-time as these assignment option selections are made by these recipients.

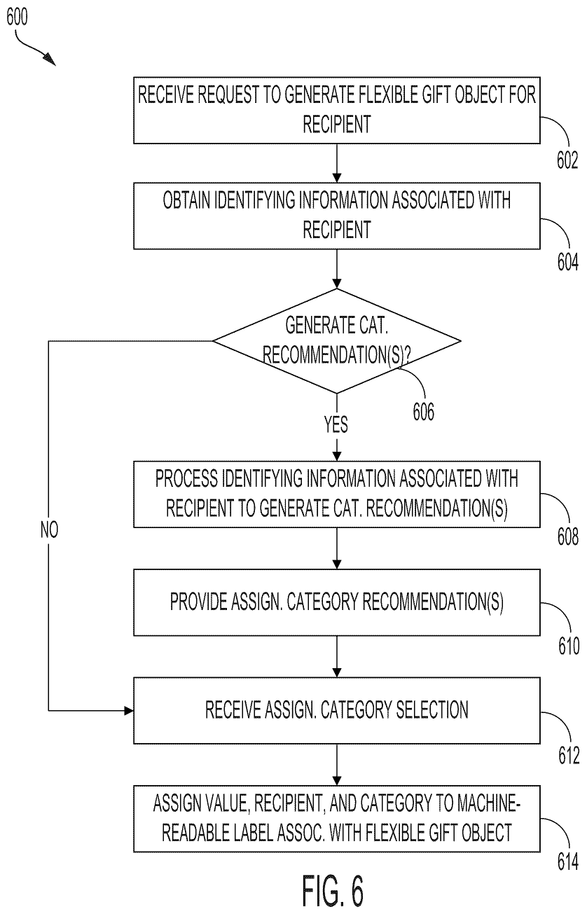

FIG. 6 shows an illustrative example of a process 600 for generating a flexible gift object for delivery to a particular recipient in accordance with at least one embodiment. The process 600 may be performed by the aforementioned flexible gift object assignment system 104 described above in connection with FIGS. 1-2 and 4A-4D. Additionally, certain operations associated with the process 600 may be performed using the assignment recommendation algorithm implemented by the flexible gift object assignment system, as described in greater detail herein.

At step 602, the flexible gift object assignment system may receive a request to generate a new flexible gift object for a particular recipient. For instance, a user may scan a machine-readable label associated with an unassigned flexible gift object to submit a request to the flexible gift object assignment system to associate the flexible gift object to a particular gift object category and to assign a monetary value to the flexible gift object. When the user scans this machine-readable label associated with the unassigned flexible gift object, the flexible gift object assignment system may receive data encoded on the machine-readable label associated with the unassigned flexible gift object. In response to receiving the data encoded in the machine-readable label, the flexible gift object assignment system may query an object datastore (e.g., the object datastore 106 described above in connection with FIGS. 1-2) to identify an entry corresponding to the machine-readable label. As noted above, the object datastore may maintain an entry for the machine-readable label that is implemented on an unassigned flexible gift object. This entry may be keyed according to the unique identifier associated with the corresponding machine-readable label such that, in response to a query including a unique identifier corresponding to the machine-readable label, the flexible gift object assignment system may be able to identify the entry corresponding to the machine-readable label from the object datastore.

At step 604, the flexible gift object assignment system may obtain identifying information associated with the intended recipient for the flexible gift object. For instance, the flexible gift object assignment system may prompt the user to provide identifying information associated with an intended recipient of the flexible gift object. This identifying information may be used by the flexible gift object assignment system to provide the user with one or more tailored recommendations corresponding to different gift object categories that may be associated with the flexible gift object and that may be appealing to the intended recipient. The identifying information that may be provided to the flexible gift object assignment system may include the intended recipient's name, the intended recipient's physical address, the intended recipient's electronic mail address, any known interests or hobbies associated with the intended recipient, and the like. Additionally, the user may indicate, with the identifying information, the specific purpose for which the flexible gift object is being provided to the intended recipient. For example, the user may indicate that the flexible gift object is being given to the intended recipient as a birthday gift for the intended recipient's child. As another example, the user may indicate that the flexible gift object is being given to the intended recipient for the recipient's upcoming vacation to Barcelona. This provided information may be used to construct a recipient profile that may be stored in a recipient information datastore (such as the recipient information datastore 208 described above in connection with FIG. 2) for use in generating tailored recommendations for gift object categories that may be provided to users looking to provide intended recipients with flexible gift objects, as well as for use in generating, for these intended recipients, tailored recommendations for particular entities that may be assigned to these flexible gift objects.

In addition to obtaining identifying information associated with the intended recipient from the user, the flexible gift object assignment system may use this identifying information to obtain additional information from an existing recipient profile and that may be used to generate tailored recommendations for the user corresponding to gift object categories that may be appealing for the intended recipient. The existing recipient profile may have previously been generated in response to earlier requests to associate different flexible gift objects for the intended recipient to different gift object categories. Further, the existing recipient profile may have previously been used to provide users and the intended recipient with different gift object category recommendations and different assignment recommendations for these different flexible gift objects. In some instances, the existing recipient profile may include additional and/or alternative identifying information or characteristics associated with the intended recipient. For example, if the gifting distribution service is associated with a financial institution through which the intended recipient may maintain a line of credit, the gifting distribution service may automatically update the recipient profile in real-time as this line of credit is used for different transactions. This information may be used to identify any spending trends associated with the intended recipient that may be used to generate tailored recommendations for gift object categories and corresponding entities that may be appealing to the intended recipient.

Based on the obtained identifying information associated with the recipient, the flexible gift object assignment system may determine, at step 606, whether to generate a set of gift object category recommendations that may be provided to the user. For instance, if the flexible gift object is already associated with a particular gift object category by default (e.g., by the flexible gift object assignment system when generating the unassigned flexible gift object, etc.), the flexible gift object assignment system may determine that generating different gift object category recommendations is not required for this particular flexible gift object. As another illustrative example, if the user has provided little in the way of recipient information for the flexible gift object (e.g., the user has only provided the recipient's name and electronic mail address, etc.) and/or the flexible gift object assignment system is unable to obtain additional recipient information that may be used to provide tailored gift object category recommendations for the flexible gift object, the flexible gift object assignment system may determine that it cannot generate gift object category recommendations for the user. Accordingly, the flexible gift object assignment system may provide the user with a listing or ordering of the different gift object categories that are available and that may be associated with the flexible gift object.

If the flexible gift object assignment system determines that it can generate one or more tailored gift object category recommendations for the user based on the obtained identifying information associated with the recipient, the flexible gift object assignment system, at step 608, may process this recipient identifying information to generate the one or more tailored gift object category recommendations. As noted above, the flexible gift object assignment system may implement an assignment recommendation algorithm, which may be dynamically trained in real-time to provide users with recommendations corresponding to different gift object categories that may be associated with their flexible gift objects and that may be appealing to the intended recipients of these flexible gift objects. The flexible gift object assignment system may use any available recipient information associated with the intended recipient (e.g., identifying information provided by the user, recipient information garnered from an existing recipient profile, etc.) and any other known information corresponding to the flexible gift object (e.g., monetary value assigned to the flexible gift object, etc.) as input to the assignment recommendation algorithm to generate a set of gift object category recommendations that may be provided to the user.

At step 610, the flexible gift object assignment system may provide any generated gift object category recommendations to the user. For instance, once the flexible gift object assignment system has generated one or more gift object category recommendations that may be presented to the user, the flexible gift object assignment system may provide these one or more gift object category recommendations. For instance, the flexible gift object assignment system may dynamically, and in real-time, update a GUI associated with the gifting application and/or the web portal/website utilized by the user to present the one or more gift object category recommendations to the user. Through the GUI or other interface associated with the gifting application and/or the web portal/website, the user may select a gift object category from the one or more gift object category recommendations to associate the selected gift object category with the flexible gift object that is to be provided to the intended recipient.

At step 612, the flexible gift object assignment system may receive a gift object category selection for the flexible gift object. This selection may be provided by the user through the aforementioned GUI associated with the gifting application and/or the web portal/website. Further, the selection may be provided by the user regardless of whether the flexible gift object assignment system provided the user with a tailored set of gift object category recommendations or with a listing of all available gift object categories that may be assigned to the flexible gift object.

At step 614, the flexible gift object assignment system may assign a monetary value, intended recipient, and the selected gift object category to the machine-readable label associated with the flexible gift object. For instance, based on the user's selection of a particular gift object category, the flexible gift object assignment system may automatically, and in real-time, update the entry corresponding to the machine-readable label implemented on the flexible gift object to associate the machine-readable label with the selected gift object category. Further, the flexible gift object assignment system may update the entry corresponding to this machine-readable label to indicate the monetary value assigned to the flexible gift object and identifying information associated with the intended recipient (e.g., recipient name, recipient electronic mail address, etc.). In some examples the flexible gift object assignment system may further associate the machine-readable label with identifying information associated with the user that is to provide the flexible gift object to the intended recipient. For instance, the flexible gift object assignment system may prompt the user to provide their name, physical address, electronic mail address, and the like that may be provided to the intended recipient when activating the flexible gift object. Additionally, the flexible gift object assignment system may prompt the user to provide a greeting or message that may be provided to the intended recipient when the intended recipient submits a request to activate the flexible gift object. The greeting or message may be provided as an audial, pictorial, and/or textual message that may be provided to the intended recipient.

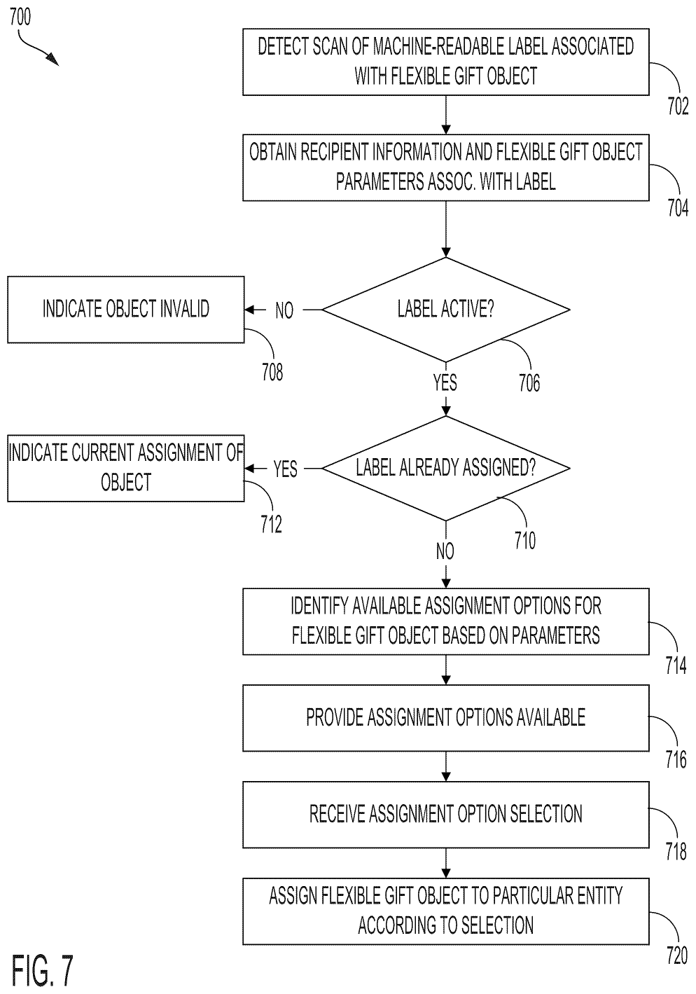

FIG. 7 shows an illustrative example of a process 700 for assigning a flexible gift object to a particular entity in response to a request to activate a flexible gift object in accordance with at least one embodiment. The process 700 may be performed by the aforementioned flexible gift object assignment system 104 described above in connection with FIGS. 1-2 and 4A-4D. Additionally, certain operations associated with the process 700 may be performed using the assignment recommendation algorithm implemented by the flexible gift object assignment system, as described in greater detail herein.

At step 702, the flexible gift object assignment system may automatically, and in real-time, detect a scan of a machine-readable label associated with a flexible gift object. As noted above, when a recipient receives a flexible gift object from a user, the recipient may scan the machine-readable label implemented on the flexible gift object to activate the flexible gift object for exclusive use with a particular retailer, merchant, or other entity. For instance, using a computing device, the recipient may scan the machine-readable label to extract the data encoded in the machine-readable label. The machine-readable label, as noted above, may encode a unique identifier corresponding to the machine-readable label. This unique identifier may correspond to an entry in the object datastore and that is associated with the machine-readable label. The entry may indicate the gift object category associated with the flexible gift object (as defined by the sender of the flexible gift object or by default by the flexible gift object assignment system) and identifying information associated with the intended recipient, as described above.

At step 704, the flexible gift object assignment system may obtain any available recipient information and defined flexible gift object parameters associated with the machine-readable label. As noted above, using the unique identifier corresponding to the machine-readable label, the flexible gift object assignment system may query an object datastore to identify an entry corresponding to the machine-readable label. Through this entry, the flexible gift object assignment system may identify the monetary value assigned to the flexible gift object, any recipient information provided by the sender of the flexible gift object and/or obtained from an existing recipient profile maintained by the flexible gift object assignment system. For instance, the entry may indicate any spending trends associated with the recipient that may be used to generate tailored recommendations for different assignment options that may be appealing to the recipient.

Through the evaluation of the entry corresponding to the machine-readable label associated with the scanned flexible gift object, the flexible gift object assignment system may determine, at step 706, whether the machine-readable label is active. For example, if the flexible gift object assignment system determines that the flexible gift object associated with the machine-readable label is expired, the flexible gift object assignment system may determine that the machine-readable label is no longer active for use. Similarly, if the flexible gift object assignment system determines that the monetary value associated with the flexible gift object has been exhausted such that the flexible gift object no longer has any value, the flexible gift object assignment system may determine that the machine-readable label is no longer active for use. In some instances, if the machine-readable label is not associated with the flexible gift object assignment system (e.g., the flexible gift object assignment system does not maintain an entry corresponding to the machine-readable label, etc.), the flexible gift object assignment system may determine that the machine-readable label is not active for use. If the flexible gift object assignment system determines that the machine-readable label is inactive, the flexible gift object assignment system, at step 708, may indicate that the flexible gift object associated with the machine-readable label is invalid.

If the flexible gift object assignment system determines that the machine-readable label is active for use, the flexible gift object assignment system may further determine, at step 710, whether the machine-readable label is currently assigned to a particular retailer, merchant, or other entity. For example, through evaluation of the entry associated with the machine-readable label, the flexible gift object assignment system may determine whether the entry indicates an identifier or other information indicative of a current assignment of the machine-readable label to a particular retailer. As noted above, if a machine-readable label is assigned to a particular retailer, merchant, or other entity, use of the flexible gift object is limited to transactions associated with this particular retailer, merchant, or other entity. Accordingly, if the machine-readable label is already assigned to a particular retailer, merchant, or other entity, the flexible gift object assignment system may, at step 712, indicate the current assignment of the flexible gift object. In some instances, in addition to providing an indication of this current assignment, the flexible gift object assignment system may provide the recipient with an option to re-assign the flexible gift object to another retailer, merchant, or entity associated with the gift object category associated with the flexible gift object, as described above.

If the flexible gift object assignment system determines that the machine-readable label associated with the flexible gift object has not been assigned to a particular retailer, merchant, or other entity, the flexible gift object assignment system, at step 714, may identify a set of available assignment options for the flexible gift object based on the identified parameters associated with the machine-readable label. For instance, based on the gift object category associated with the machine-readable label, the flexible gift object assignment system may identify a set of retailers, merchants, and/or other entities corresponding to the gift object category. As an illustrative example, a gift object category corresponding to “coffee” may be associated with one or more coffee vendors that may provide, online and/or through one or more point-of-sale locations, different coffee-related goods and/or services. As another illustrative example, a gift object category corresponding to “restaurants” may be associated with one or more different participating restaurants through which the flexible gift object may be used.

In an embodiment, the available assignment options for the flexible gift object can be identified using the aforementioned assignment recommendation algorithm based on any available recipient information and the gift object category associated with the machine-readable label. For instance, the flexible gift object assignment system may use the gift object category associated with the flexible gift object and the obtained recipient information (as provided by the recipient, as obtained from the entry corresponding to the machine-readable label, and/or obtained from the recipient information datastore) as input to the assignment recommendation algorithm to automatically, and in real-time, generate one or more assignment recommendations that may be provided to the recipient. These one or more assignment recommendations may correspond to one or more particular retailers, merchants, or other entities associated with the gift object category that may be appealing to the recipient for assignment of the flexible gift object. In some instances, if the flexible gift object assignment system determines that additional information associated with the recipient may be beneficial in providing more accurate recommendations to the recipient, the flexible gift object assignment system may prompt the recipient for this additional information. This additional information may be used to supplement the existing recipient profile associated with the recipient.

At step 716, the flexible gift object assignment system may provide the recipient with any available assignment selection options corresponding to the gift object category associated with the machine-readable label. For instance, the flexible gift object assignment system may provide the recipient with a listing or other ordering of the set of retailers, merchants, and/or other entities that are associated with the gift object category. If the flexible gift object assignment system, through the assignment recommendation algorithm, generates one or more assignment recommendations corresponding to different retailers, merchants, and/or entities that may be appealing to the recipient, the flexible gift object assignment system may provide the recipient with these assignment recommendations. In an embodiment, the flexible gift object assignment system automatically sorts the set of assignment selection options based on a determined likelihood of the recipient selecting a corresponding assignment selection option. For example, any assignment selection options corresponding to the assignment recommendations generated by the assignment recommendation algorithm may be prioritized over other selection options corresponding to the gift object category associated with the flexible gift object that may not have been recommended by the assignment recommendation algorithm. As another illustrative example, the set of assignment selection options may be ordered according to the known frequency at which the recipient has purchased goods and/or services from the different retailers, merchants, and/or other entities associated with the set of assignment selection options, as determined through the recipient profile associated with the recipient. In some instances, the set of assignment selection options may be alternatively sorted according to one or more other criteria. For example, the set of assignment selection options may be ordered alphabetically. As another illustrative example, the set of assignment selection options may be ordered according to the proximity between the recipient's physical address and point-of-sale locations associated with the myriad retailers and/or merchants associated with the gift object category associated with the flexible gift object.

At step 718, the flexible gift object assignment system may receive a recipient's selection of a particular assignment selection option from the set of assignment selection options provided to the recipient. For instance, through the gifting application or website/web portal provided by the gifting distribution service, the recipient may indicate their selected assignment selection option for the flexible gift object. The selected assignment selection option may correspond to a particular retailer, merchant, or other entity that the recipient wishes to assign to the flexible gift object such that the flexible gift object may be exclusively used with this particular retailer, merchant, or other entity.

In response to the recipient's selection of a particular retailer, merchant, or other entity that is to be assigned to the flexible gift object for exclusive use of the flexible gift object with this particular retailer, merchant, or other entity, the flexible gift object assignment system, at step 720, may automatically update the entry corresponding to the machine-readable label implemented on the flexible gift object to complete this assignment. The resulting entry, for instance, may include an indication of the gift object category associated with the machine-readable label, as well as an indication of the retailer, merchant, or other entity that has been assigned to the machine-readable label. Through this update, the flexible gift object may be designated for use exclusively with the assigned retailer, merchant, or other entity. In some instances, in addition to updating the entry corresponding to the machine-readable label to indicate this assignment, the flexible gift object assignment system may transmit data corresponding to the machine-readable label to one or more systems associated with the assigned retailer, merchant, or other entity to allow the assigned retailer, merchant, or other entity to process transactions associated with the flexible gift object. This data may include the unique identifier corresponding to the machine-readable label and the monetary amount associated with the flexible gift object. This may allow the assigned retailer, merchant, or other entity to process transactions involving the flexible gift object locally (such as through a point-of-sale terminal associated with the assigned retailer, merchant, or other entity) without requiring access to the gifting distribution service for processing the transaction.

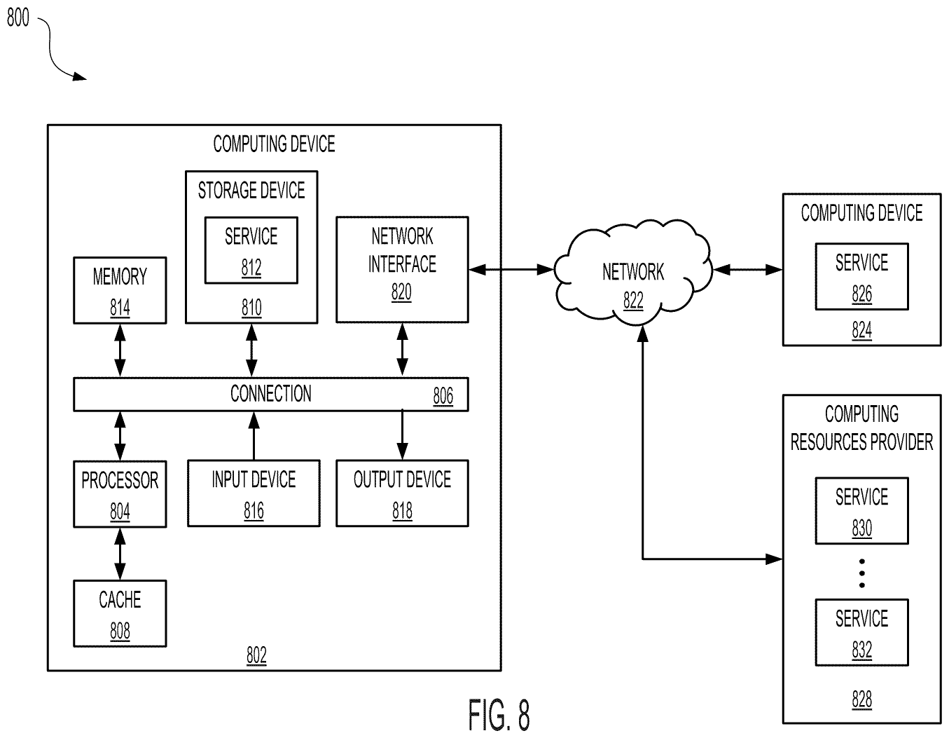

FIG. 8 illustrates a computing system architecture 800, including various components in electrical communication with each other, in accordance with some embodiments. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In an embodiment, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed processes for generating flexible gift objects can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating flexible gift objects described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described above, the connector 806 (or bus) can also couple the processor 804 to the storage device 810, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/O devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g. network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 802) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6-7). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a gifting request to associate a flexible gift object with a recipient, wherein the gifting request includes identifying information associated with the recipient, wherein the gifting request defines a gift object category, and wherein the flexible gift object includes a machine-readable label;
dynamically associating the machine-readable label with the identifying information associated with the recipient and the gift object category through data encoded in the machine-readable label;
receiving an activation request to activate the flexible gift object, wherein the activation request includes the data, and wherein the data is extracted from the machine-readable label;
processing the data extracted from the machine-readable label in real-time to retrieve the identifying information associated with the recipient and the gift object category;
providing a set of assignment options corresponding to the gift object category, wherein the set of assignment options correspond to entities associated with the gift object category;
receiving a selection of an assignment option, wherein the selection corresponds to a particular entity associated with the gift object category; and
dynamically associating the data encoded in the machine-readable label with the particular entity, wherein when the data is dynamically associated with the particular entity, the flexible gift object is activated for use in transactions associated with the particular entity.

2. The computer-implemented method of claim 1, wherein the machine-readable label is a Quick Response (QR) code.

3. The computer-implemented method of claim 1, further comprising:
automatically generating a set of recommendations corresponding to different gift object categories for defining the flexible gift object, wherein the set of recommendations are generated based on the identifying information associated with the recipient; and
providing the set of recommendations, wherein when the set of recommendations are received, the gift object category is selected for the gifting request.

4. The computer-implemented method of claim 1, further comprising:
automatically generating a set of recommendations corresponding to the set of assignment options, wherein the set of recommendations are generated based on the identifying information associated with the recipient and the gift object category; and
providing the set of recommendations.

5. The computer-implemented method of claim 1, wherein the activation request is received as a result of the machine-readable label being scanned using a computing device associated with the recipient.

6. The computer-implemented method of claim 1, wherein the gifting request is received as a result of the machine-readable label being scanned using a computing device associated with a sender of the flexible gift object.

7. The computer-implemented method of claim 1, wherein the activation request is received through a point-of-sale terminal associated with the particular entity.

8. A system, comprising:
one or more processors; and
memory storing thereon instructions that, as a result of being executed by the one or more processors, cause the system to:
receive a gifting request to associate a flexible gift object with a recipient, wherein the gifting request includes identifying information associated with the recipient, wherein the gifting request defines a gift object category, and wherein the flexible gift object includes a machine-readable label;
dynamically associate the machine-readable label with the identifying information associated with the recipient and the gift object category through data encoded in the machine-readable label;
receive an activation request to activate the flexible gift object, wherein the activation request includes the data, and wherein the data is extracted from the machine-readable label;
process the data extracted from the machine-readable label in real-time to retrieve the identifying information associated with the recipient and the gift object category;
provide a set of assignment options corresponding to the gift object category, wherein the set of assignment options correspond to entities associated with the gift object category;
receive a selection of an assignment option, wherein the selection corresponds to a particular entity associated with the gift object category; and
dynamically associate the data encoded in the machine-readable label with the particular entity, wherein when the data is dynamically associated with the particular entity, the flexible gift object is activated for use in transactions associated with the particular entity.

9. The system of claim 8, wherein the machine-readable label is a Quick Response (QR) code.

10. The system of claim 8, wherein the instructions further cause the system to:
automatically generate a set of recommendations corresponding to different gift object categories for defining the flexible gift object, wherein the set of recommendations are generated based on the identifying information associated with the recipient; and
provide the set of recommendations, wherein when the set of recommendations are received, the gift object category is selected for the gifting request.

11. The system of claim 8, wherein the instructions further cause the system to:
automatically generate a set of recommendations corresponding to the set of assignment options, wherein the set of recommendations are generated based on the identifying information associated with the recipient and the gift object category; and
provide the set of recommendations.

12. The system of claim 8, wherein the activation request is received as a result of the machine-readable label being scanned using a computing device associated with the recipient.

13. The system of claim 8, wherein the gifting request is received as a result of the machine-readable label being scanned using a computing device associated with a sender of the flexible gift object.

14. The system of claim 8, wherein the activation request is received through a point-of-sale terminal associated with the particular entity.

15. A non-transitory, computer-readable storage medium storing thereon executable instructions that, as a result of being executed by one or more processors of a computer system, cause the computer system to:
receive a gifting request to associate a flexible gift object with a recipient, wherein the gifting request includes identifying information associated with the recipient, wherein the gifting request defines a gift object category, and wherein the flexible gift object includes a machine-readable label;
dynamically associate the machine-readable label with the identifying information associated with the recipient and the gift object category through data encoded in the machine-readable label;
receive an activation request to activate the flexible gift object, wherein the activation request includes the data, and wherein the data is extracted from the machine-readable label;
process the data extracted from the machine-readable label in real-time to retrieve the identifying information associated with the recipient and the gift object category;
provide a set of assignment options corresponding to the gift object category, wherein the set of assignment options correspond to entities associated with the gift object category;
receive a selection of an assignment option, wherein the selection corresponds to a particular entity associated with the gift object category; and
dynamically associate the data encoded in the machine-readable label with the particular entity, wherein when the data is dynamically associated with the particular entity, the flexible gift object is activated for use in transactions associated with the particular entity.

16. The non-transitory, computer-readable storage medium of claim 15, wherein the machine-readable label is a Quick Response (QR) code.

17. The non-transitory, computer-readable storage medium of claim 15, wherein the executable instructions further cause the computer system to:
automatically generate a set of recommendations corresponding to different gift object categories for defining the flexible gift object, wherein the set of recommendations are generated based on the identifying information associated with the recipient; and
provide the set of recommendations, wherein when the set of recommendations are received, the gift object category is selected for the gifting request.

18. The non-transitory, computer-readable storage medium of claim 15, wherein the executable instructions further cause the computer system to:
automatically generate a set of recommendations corresponding to the set of assignment options, wherein the set of recommendations are generated based on the identifying information associated with the recipient and the gift object category; and
provide the set of recommendations.

19. The non-transitory, computer-readable storage medium of claim 15, wherein the activation request is received as a result of the machine-readable label being scanned using a computing device associated with the recipient.

20. The non-transitory, computer-readable storage medium of claim 15, wherein the gifting request is received as a result of the machine-readable label being scanned using a computing device associated with a sender of the flexible gift object.

21. The non-transitory, computer-readable storage medium of claim 15, wherein the activation request is received through a point-of-sale terminal associated with the particular entity.
